(19) United States
(12) Patent Application Publication
(10) Pub. No.: US 2026/0044309 A1
(43) Pub. Date: Feb. 12, 2026

(54) ELECTRONIC APPARATUS AND CONTROL METHOD THEREOF

(71) Applicant: Samsung Electronics Co., Ltd., Suwon-si (KR)

(72) Inventors: Yeonwoo KIM, Suwon-si (KR); Soohyang KIM, Suwon-si (KR); Jingjing ZHANG, Nanjing (CN); Jun SHAO, Nanjing (CN); Kai GUO, Nanjing (CN); Yangyang LIU, Nanjing (CN)

(73) Assignee: Samsung Electronics Co., Ltd., Suwon-si (KR)

(21) Appl. No.: 19/267,891

(22) Filed: Jul. 14, 2025

Related U.S. Application Data
(63) Continuation of application No. PCT/KR2025/006389, filed on May 12, 2025.

(30) Foreign Application Priority Data
Aug. 9, 2024 (KR) 10-2024-0107117

(51) Int. Cl. G06F 3/16; G01S 15/04; G06F 3/04842; G09G 3/3225; G09G 5/00

(52) U.S. Cl. CPC G06F 3/167; G01S 15/04; G06F 3/04842; G09G 3/3225; G09G 5/003; G09G 2330/023; G09G 2354/00

(57) ABSTRACT

Disclosed is an electronic apparatus. The electronic apparatus includes memory configured to store instructions, a display, a speaker, a microphone and at least one processor including processing circuitry, and the instructions, when executed by the at least one processor individually or collectively, cause the electronic apparatus to obtain a first audio signal through the microphone, based on a predetermined sound being identified based on a first audio signal, output ultrasonic waves through the speaker, obtain a second audio signal including reflective waves corresponding to the ultrasonic waves through the microphone, and based on identifying that a user is present around the electronic apparatus based on the second audio signal, perform a predetermined function.

### CROSS-REFERENCE TO RELATED APPLICATION

This application is a bypass continuation of International Application No. PCT/KR2025/006389, filed on May 12, 2025, which is based on and claims priority to Korean Patent Application No. 10-2024-0107117, filed on Aug. 9, 2024, in the Korean Intellectual Property Office, the disclosures of which are incorporated by reference herein in their entireties.

### TECHNICAL FIELD

This disclosure relates to an electronic apparatus and a control method thereof, and particularly to, an electronic apparatus identifying whether a user is close by using ultrasonic waves and a control method thereof.

### BACKGROUND ART

Electronic apparatuses may perform a specific function only in the situation where a user is close, to secure power efficiency. For example, lighting sensors may light a user only in the case where a user goes by. Electronic apparatuses may also perform a specific function only in the situation where a user is recognized.

An electronic apparatus may use a variety of methods to recognize a user. In the case where an image sensor is used to recognize a user, it may take long time to analyze an image. An ultrasonic sensor may be used to recognize a user, but an electronic apparatus without an ultrasonic sensor may not recognize a user.

In the case where an audio signal obtained from a microphone is only used to recognize a user, high accuracy may not be ensured. When an audio signal included in audible frequencies is only used to recognize a user, recognition accuracy through the audio signal may be less than that through the ultrasonic sensor.

In the case where ultrasonic waves are output through the ultrasonic sensor, there is a problem in that animals or infants may hear the ultrasonic waves.

### DISCLOSURE

### Technical Solution

Embodiments of the disclosure provide an electronic apparatus sensing a user by using both a first audio signal including no ultrasonic waves and a second audio signal including ultrasonic waves and a control method thereof.

According to an embodiment, an electronic apparatus includes memory configured to store instructions, a display, a speaker, a microphone and at least one processor including processing circuitry, and the instructions, when executed by the at least one processor individually or collectively, causes the electronic apparatus to based on a predetermined sound being identified based on a first audio signal obtained through the microphone, output ultrasonic waves through the speaker, and based on identifying that a user is present around the electronic apparatus based on a second audio signal obtained through the microphone and including reflective waves corresponding to the ultrasonic waves output through the speaker, perform a function corresponding to presence of the user.

The predetermined sound may include an artificial sound based on human behavior.

The instructions, when executed by the at least one processor individually or collectively, may cause the electronic apparatus to obtain an average sound pressure of the first audio signal, and based on the average sound pressure being equal to or greater than a predetermined sound pressure, determine whether the predetermined sound is identified based on the first audio signal.

The instructions, when executed by the at least one processor individually or collectively, may cause the electronic apparatus to, based on the predetermined sound being identified based on the first audio signal, identify whether the electronic apparatus is in a state in which output of ultrasonic waves is impossible, and based on identifying that the electronic apparatus is not in a state in which output of ultrasonic waves is impossible, output the ultrasonic waves through the speaker, and the state in which output of ultrasonic waves is impossible may include a state in which at least one of the speaker or the microphone is activated.

The instructions, when executed by the at least one processor individually or collectively, may cause the electronic apparatus to obtain the first audio signal while the electronic apparatus operates in a low power state, and based on the electronic apparatus not being in a state in which output of ultrasonic waves is impossible, change the low power state to a standby state.

The instructions, when executed by the at least one processor individually or collectively, may cause the electronic apparatus to obtain a target audio signal by filtering out noise from the second audio signal based on a noise threshold value, and identify whether the user is present around the electronic apparatus based on the ultrasonic waves and reflective waves corresponding to the ultrasonic waves obtained from the target audio signal.

The instructions, when executed by the at least one processor individually or collectively, may cause the electronic apparatus to obtain a phase difference value based on a first phase of the ultrasonic waves and a second phase of the reflective waves obtained from the target audio signal, and based on the phase difference value being equal to or greater than a phase threshold value, identify that the user is present around the electronic apparatus.

The electronic apparatus may further include a display, and the instructions, when executed by the at least one processor individually or collectively, may cause the electronic apparatus to based on identifying that the user is present around the electronic apparatus, control the display to display a predetermined screen, and the predetermined screen may include at least one of a time UI, a weather UI, a schedule UI, an indoor environment UI, and/or a guide UI.

The ultrasonic waves may be first ultrasonic waves and the reflective waves obtained from the target audio signal may be first reflective waves, and the instructions, when executed by the at least one processor individually or collectively, may cause the electronic apparatus to output second ultrasonic waves through the speaker, after displaying the predetermined screen, obtain a third audio signal including second reflective waves corresponding to the second ultrasonic waves through the microphone, and based on identifying that the user is present around the electronic apparatus based on the third audio signal, control the display to display the predetermined screen continuously.

The instructions, when executed by the at least one processor individually or collectively, may cause the electronic apparatus to obtain a first average value of a first threshold number of phase difference values corresponding to a first sensitivity from the second audio signal, based on the first average value being equal to or greater than the phase threshold value, control the display to display the predetermined screen, obtain a second average value of a second threshold number of phase difference values corresponding to a second sensitivity from the third audio signal, and based on the second average value being less than the phase threshold value, control the display not to display the predetermined screen, and the first threshold number may be greater than the second threshold number.

According to an embodiment of the disclosure, a control method of an electronic apparatus including a speaker and a microphone includes, based on a predetermined sound being identified based on a first audio signal obtained through the microphone, outputting ultrasonic waves through the speaker, and based on identifying that a user is present around the electronic apparatus based on a second audio signal obtained through the microphone and including reflective waves corresponding to the ultrasonic waves output through the speaker, performing a function corresponding to presence of the user.

The predetermined sound may include an artificial sound based on human behavior.

The control method may include obtaining an average sound pressure of the first audio signal, and based on the average sound pressure being equal to or greater than a predetermined sound pressure, determining whether the predetermined sound is identified based on the first audio signal.

The control method may include based on the predetermined sound being identified based on the first audio signal, identifying whether the electronic apparatus is in a state in which output of ultrasonic waves is impossible, and based on identifying that the electronic apparatus is not in a state in which output of ultrasonic waves is impossible, outputting the ultrasonic waves through the speaker, and the state in which output of ultrasonic waves is impossible may include a state in which at least one of the speaker or the microphone is activated.

The control method may include obtaining the first audio signal while the electronic apparatus operates in a low power state, and based on the electronic apparatus not being in a state in which output of ultrasonic waves is impossible, changing the low power state to a standby state.

The control method may include obtaining a target audio signal by filtering out noise from the second audio signal based on a noise threshold value stored previously, and identifying whether the user is present around the electronic apparatus based on the ultrasonic waves and reflective waves corresponding to the ultrasonic waves obtained from the target audio signal.

The control method may include obtaining a phase difference value based on a first phase of the ultrasonic waves and a second phase of the reflective waves, and based on the phase difference value being equal to or greater than a phase threshold value, identifying that the user is present around the electronic apparatus.

The performing a function may include based on identifying that the user is present around the electronic apparatus, displaying a predetermined screen, and the predetermined screen may include at least one of a time UI, a weather UI, a schedule UI, an indoor environment UI, and/or a guide UI.

The ultrasonic waves may be first ultrasonic waves and the reflective waves may be first reflective waves, and the method may include outputting second ultrasonic waves through the speaker, after displaying the predetermined screen, obtaining a third audio signal including second reflective waves corresponding to the second ultrasonic waves through the microphone, and based on identifying that the user is present around the electronic apparatus based on the third audio signal, displaying the predetermined screen continuously.

The control method may include obtaining a first average value of a first threshold number of phase difference values corresponding to first sensitivity from the second audio signal, based on the first average value being equal to or greater than the phase threshold value, controlling the display to display the predetermined screen, obtaining a second average value of a second threshold number of phase difference values corresponding to second sensitivity from the third audio signal, and based on the second average value being less than the phase threshold value, displaying the predetermined screen, and the first threshold number may be greater than the second threshold number.

According to an embodiment of the disclosure, an electronic apparatus may include a microphone, a speaker, at least one processor; and memory storing instructions that, when executed by the at least one processor, cause the electronic apparatus to (a) obtain, through the microphone, a first audio signal, (b) based on a predetermined sound being identified based on a first audio signal obtained through the microphone, output ultrasonic waves through the speaker, (c) obtain, through the microphone, a second audio signal including reflective waves corresponding to the ultrasonic waves output through the speaker, and (d) based on identifying that a user is present around the electronic apparatus based on the second audio signal obtained through the microphone, perform a function corresponding to presence of the user.

### DESCRIPTION OF DRAWINGS

FIG. 1 is a view provided to explain an operation of sensing a user around an electronic apparatus, according to an embodiment;

FIG. 2 is a block diagram illustrating an electronic apparatus, according to an embodiment;

FIG. 3 is a block diagram provided to explain a specific configuration of the electronic apparatus of FIG. 2, according to an embodiment;

FIG. 4 is a view provided to a three-stage operation for identifying whether a user is close, according to an embodiment;

FIG. 5 is a view provided to explain a screen provided depending on a predetermined event, according to an embodiment;

FIG. 6 is a view provided to explain a first sensing operation, according to an embodiment;

FIG. 7 is a view provided to explain a second sensing operation, according to an embodiment;

FIG. 8 is a view provided to explain a third sensing operation, according to an embodiment;

FIG. 9 is a view provided to explain an operation of treating noise, according to an embodiment;

FIG. 10 is a view provided to explain an operation of treating normal noise, according to an embodiment;

FIG. 11 is a view provided to explain an operation of treating noise depending on a microphone, according to an embodiment;

FIG. 12 is a view provided to explain noise and ultrasonic waves, according to an embodiment;

FIG. 13 is a view provided to explain an operation of selecting one microphone from a two-channel microphone, according to an embodiment;

FIG. 14 is a view provided to explain an operation of selecting one microphone from a two-channel microphone, according to an embodiment;

FIG. 15 is a view provided to explain a plurality of states in which an electronic apparatus operates, according to an embodiment;

FIG. 16 is a view provided to explain an operation of treating noise based on a change in a state, according to an embodiment;

FIG. 17 is a view provided to explain noise based on a change in a state, according to an embodiment;

FIG. 18 is a view provided to explain an operation of treating noise based on a change in a state, according to an embodiment;

FIG. 19 is a view provided to explain an operation of applying different sensitivity to each sensing operation, according to an embodiment;

FIG. 20 is a view provided to explain sensitivity, according to an embodiment;

FIG. 21 is a view provided to explain an operation applying different sensitivity to each sensing operation, according to an embodiment;

FIG. 22 is a view provided to explain an operation of adjusting sensitivity, according to an embodiment;

FIG. 23 is a view provided to explain sound pressure measurement data, according to an embodiment;

FIG. 24 is a view provided to explain conditions for performing a noise test, according to an embodiment;

FIG. 25 is a view provided to explain an operation of obtaining noise information, according to an embodiment;

FIG. 26 is a view provided to explain a process of obtaining noise information, according to an embodiment;

FIG. 27 is a view provided to explain noise information on a plurality of bands, according to an embodiment;

FIG. 28 is a view provided to explain an operation of analyzing noise information on a plurality of bands, according to an embodiment;

FIG. 29 is a view provided to explain an operation of performing a noise test, according to an embodiment; and

FIG. 30 is a view provided to explain, according to an embodiment.

### MODE FOR INVENTION

Hereinafter, the subject matter of the present disclosure is described with reference to the accompanying drawings.

General terms currently widely used are selected as the terms used in the embodiments of the disclosure in consideration of their functions in the disclosure, but may be changed based on the intention of one skilled in the art or a judicial precedent, the emergence of a new technology, or the like. In addition, in a specific case, terms arbitrarily chosen by the applicant may be included in the terms used herein. In this case, the meanings of such terms are provided in detail in the corresponding descriptions of the disclosure. Therefore, the terms used in the embodiments of the disclosure need to be defined on the basis of meanings thereof and overall details throughout the disclosure rather than simply names thereof.

In the disclosure, the expression “have”, “may have”, “include”, “may include” or the like, indicates the existence of a corresponding feature (e.g., a numerical value, a function, an operation or an element such as a part), and does not exclude the existence of an additional feature.

The expression at least one from A and/or B is to be understood as indicating any one of “A” or “B” or “A and B”.

The expression “and/or” includes any and all combinations of one or more of the associated listed items.

Expressions such as “at least one of A and B”, “at least one of A, and B”, “at least one of A and/or B”, “at least of A, and/or B”, and similar expressions, as used herein, includes any of the following: A, B, A and B.

Expressions such as “at least one of A, B and C”, “at least one of A, B, and C”, “at least one of A, B and/or C”, “at least one of A, B, and/or C” and similar expressions, as used herein, includes any of the following: A, B, C, A and B, A and C, B and C, A and B and C.

The expression “1st”, “2nd”, “first”, “second”, or the like, used in the disclosure, may be used to modify various elements regardless of their order and/or importance, and may be used merely to differentiate one element from another but not be intended to limit corresponding elements.

Based on one element (e.g., a first element) referred to as being “(operatively or communicatively) coupled with/to” or “connected with/to” another element (e.g., a second element), it is to be understood that one element may connect to another element directly, or through yet another element (e.g., a third element).

In the disclosure, singular forms include plural forms as well, unless explicitly indicated otherwise. In the disclosure, the term “include” or “composed of” and the like specify the presence of stated features, integers, steps, operations, elements, components or combinations thereof but do not imply the exclusion of the presence or addition of one or more other features, integers, steps, operations, elements, components or combinations thereof.

In the disclosure, the term “module” or “unit” may perform at least one function or operation, and be implemented by hardware or software or by a combination of hardware and software. In addition, a plurality of “modules” or a plurality of “units” may be integrated into at least one module and be implemented by at least one processor except for a “module” or a “unit” that needs to be implemented by specific hardware.

In the disclosure, the term “user” may refer to a human using an electronic apparatus or an apparatus using an electronic apparatus (e.g., an artificial intelligence electronic apparatus).

Hereinafter, an embodiment of the present disclosure is described in greater detail with reference to the accompanying drawings.

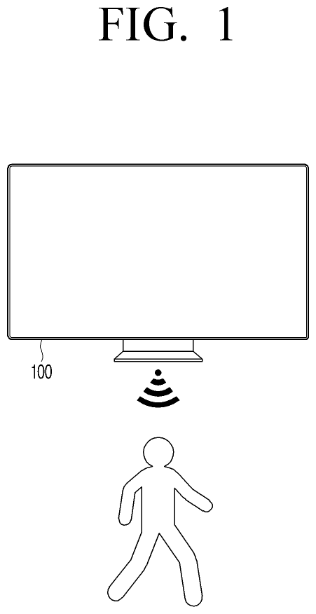

FIG. 1 is a view provided to explain an operation of sensing a user around an electronic apparatus, according to an embodiment.

Referring to FIG. 1, the electronic apparatus 100 may sense a user who is present in a surrounding space. The electronic apparatus 100 may identify whether a user is present in various ways.

According to an embodiment, the electronic apparatus 100 may identify a user through an image. The electronic apparatus 100 may include an image sensor (e.g., a camera). The electronic apparatus 100 may capture an image of a surrounding space of the electronic apparatus (100) through the image sensor. The electronic apparatus 100 may obtain a captured image through the image sensor. The electronic apparatus 100 may identify whether a human object is included in the captured image.

According to an embodiment, the electronic apparatus 100 may check a user through an ultrasonic signal. The electronic apparatus 100 may include an ultrasonic sensor. The electronic apparatus 100 may output ultrasonic waves for transmission to a surrounding space of the electronic apparatus 100 through the ultrasonic sensor. The electronic apparatus 100 may obtain ultrasonic waves for receipt through the ultrasonic sensor. The ultrasonic waves for receipt may be described as reflective waves. Based on the obtained ultrasonic signal for receipt, the electronic apparatus 100 may check whether a user is close.

According to an embodiment, the electronic apparatus 100 may identify a user through an ultrasonic signal in a state where the electronic apparatus 100 is not provided with a separate ultrasonic sensor. The electronic apparatus 100 may output ultrasonic waves for transmission through a speaker. The electronic apparatus 100 may obtain ultrasonic waves for receipt through a microphone. The electronic apparatus 100 may obtain an audio signal that is recorded through the microphone. The electronic apparatus 100 may obtain ultrasonic waves for receipt (or reflective waves) based on the audio signal. The electronic apparatus 100 may determine whether a user is close (or present) based on the ultrasonic waves for receipt (or reflective waves).

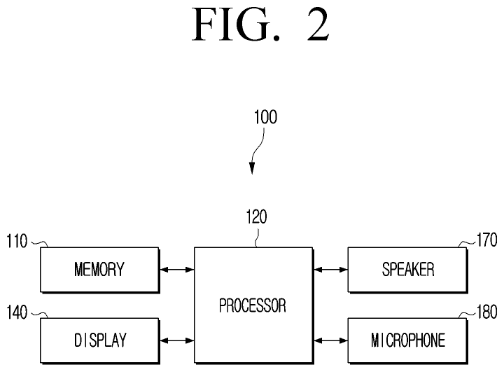

FIG. 2 is a block diagram illustrating an electronic apparatus, according to an embodiment.

Referring to FIG. 2, the electronic apparatus 100 may include various types of devices including a display 140. The electronic apparatus 100 may be an electronic whiteboard, a TV, a desktop PC, a laptop computer, a smartphone, a tablet PC, a server and the like. The devices described above are provided only as examples, and the electronic apparatus 100 is not necessarily limited to the devices described above.

At least one processor 120 may perform an overall control operation of the electronic apparatus 100. The at least one processor 120 may perform a function of controlling an overall operation of the electronic apparatus 100.

The electronic apparatus 100 may include at least one processor 120 including memory 110 storing instructions, a display 140, a speaker 170, a microphone 180, and processing circuitry.

The at least one processor 120 may obtain a first audio signal through the microphone 180, output ultrasonic waves through the speaker 170 when a predetermined sound is identified based on the first audio signal, obtain a second audio signal including reflective waves corresponding to ultrasonic waves through the microphone 180, and perform a predetermined function when it is identified that a user is present around the electronic apparatus 100 based on the second audio signal.

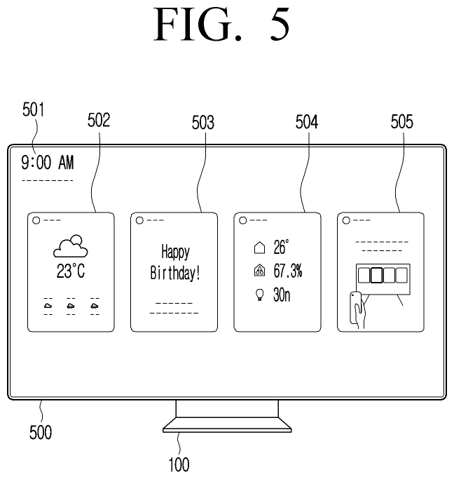

The at least one processor 120 may perform a predetermined function depending on whether a user approaches. The predetermined function may include at least one of the functions of providing information to a user and/or providing a notification to a user. In the case where a user is present around the electronic apparatus 100, the at least one processor 120 may display a predetermined screen. The predetermined screen is described with reference to FIG. 5.

The at least one processor 120 may perform a sensing operation as to whether a user is present around the electronic apparatus 100. The sensing operation may be performed in three stages. The sensing operation may include a first sensing operation, a second sensing operation and a third sensing operation.

The operation of identifying whether a user is present around the electronic apparatus 100 may be described as an operation of identifying whether a user is positioned around the electronic apparatus 100. The operation of identifying whether a user is present around the electronic apparatus 100 may be described as an operation of identifying whether a user is present within a threshold distance from the electronic apparatus 100.

The first sensing operation may be an operation of determining whether a user is close, based on a normal audio signal, without ultrasonic waves. The first sensing operation may be a prerequisite for the second sensing operation.

The second sensing operation may be an operation of determining whether a user is close by outputting ultrasonic waves when the predetermined sound is identified in the first sensing operation. In the case where a user is identified based on the second sensing operation, the at least one processor 120 may perform the predetermined function.

The third sensing operation may be an operation of sensing a user while the predetermined function is performed. For the predetermined function to be performed, a user needs to be identified around the electronic apparatus 100 continuously. In the case where the user is identified based on the third sensing operation, the at least one processor 120 may continue to perform the predetermined function. In the case where a user is not identified based on the third sensing operation, the at least one processor 120 may end the predetermined function.

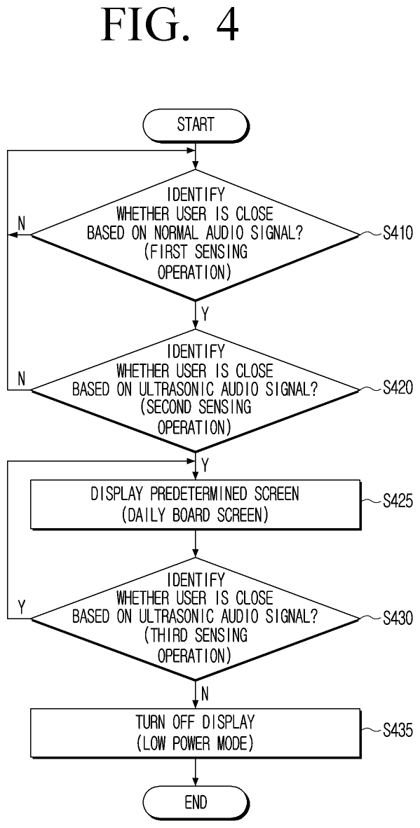

The first sensing operation, the second sensing operation and the third sensing operation are described with reference to FIG. 4

The at least one processor 120 may obtain a first audio signal through the microphone 180 in the state where the at least one processor 120 does not output ultrasonic waves. The first audio signal may be used in the first sensing operation. The at least one processor 120 may identify whether a predetermined sound is included in the first audio signal.

The predetermined sound may include an artificial sound based on human behavior.

The predetermined sound may include at least one of a human voice or an artificial sound caused by human behavior. The predetermined sound may be a sound indicating that a human is present nearby. For example, the predetermined sound may include at least one of a voice, a footstep, a clapping sound, a laughing sound, a conversation sound, a crying sound, a door opening and closing sound, a water-tap opening sound, a yawning sound and/or a coughing sound.

As the first sensing operation, the at least one processor 120 may obtain average sound pressure of the first audio signal, and in the case where the average sound pressure is equal to or greater than predetermined sound pressure, may determine whether the predetermined sound is identified, based on the first audio signal.

The at least one processor 120 may obtain average sound pressure of the first audio signal for a period during which the first audio signal is obtained. The at least one processor 120 may determine whether the average sound pressure is equal to or greater than the predetermined sound pressure. At sound pressure less than the predetermined sound pressure, it may be difficult to identify the predetermined sound.

In the case where the average sound pressure is equal to or greater than the predetermined sound pressure, the at least one processor 120 may determine whether the predetermined sound is included in the first audio signal.

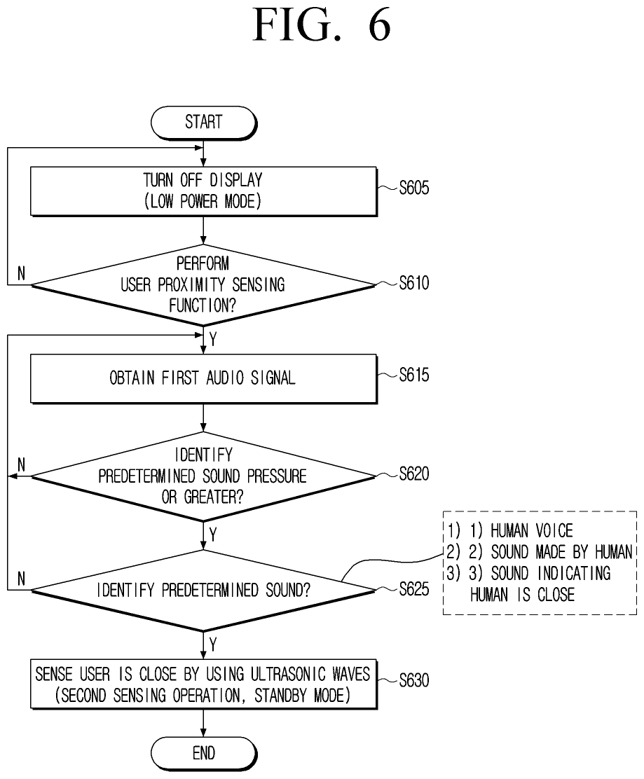

Operations regarding the first sensing operation are described with reference to FIG. 6.

The at least one processor 120 may identify whether the electronic apparatus 100 is in a state where output of ultrasonic waves is impossible, when the predetermined sound is identified based on the first audio signal, and in the case where the electronic apparatus 100 is not in the state where output of ultrasonic waves is impossible, output ultrasonic waves through the speaker 170. The ultrasonic-wave output impossible state may include a state in which at least one of the speaker 170 or the microphone 180 is activated. The state may be described as a mode.

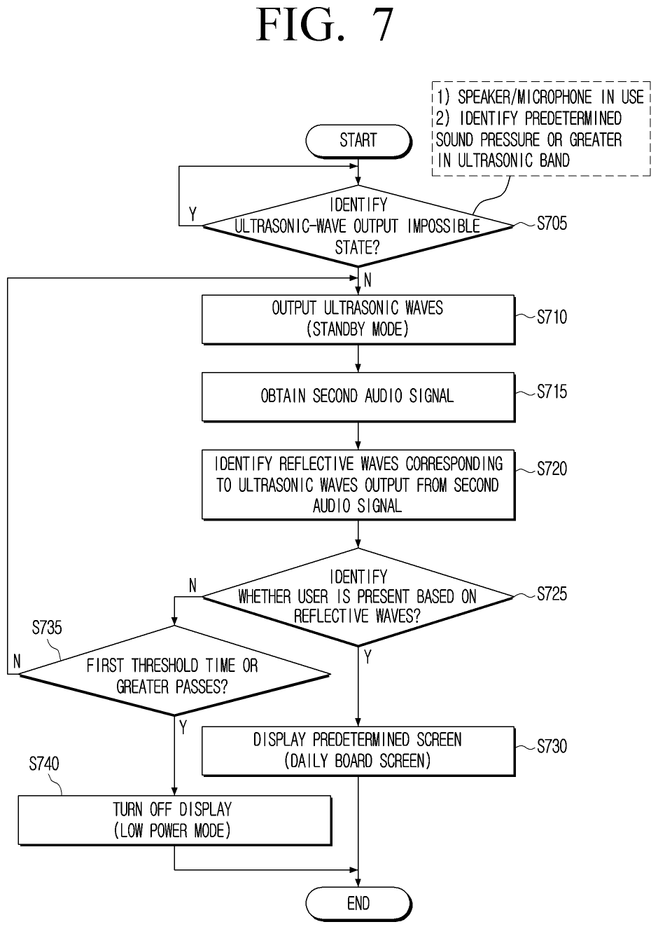

In the case where the predetermined sound is identified based on the first audio signal, the at least one processor 120 may perform the second sensing operation. The second sensing operation is described with reference to FIG. 7.

The at least one processor 120 may identify the state of the electronic apparatus 100. The at least one processor 120 may identify whether the state of the electronic apparatus 100 is in the ultrasonic wave-output impossible state.

The ultrasonic wave-output impossible state may include a state in which the speaker 170 is activated. For example, in the case where an audio signal corresponding to contents is output through the speaker 170, the electronic apparatus 100 may be in the ultrasonic wave-output impossible state.

The ultrasonic wave-output impossible state may include a state in which the microphone 180 is activated. For example, in the case where a voice recognition function is performed, the electronic apparatus 100 may be in the ultrasonic wave-output impossible state.

The second sensing operation requires performing a function of outputting ultrasonic waves necessarily. The at least one processor 120 may not perform the second sensing operation in the ultrasonic wave-output impossible state.

In the case where the electronic apparatus 100 is not in the ultrasonic wave-output impossible state, the at least one processor 120 may output ultrasonic waves through the speaker 170.

The electronic apparatus 100 may operate in a low power state during the performance of the first sensing operation. During the first sensing operation, the predetermined screen may not be displayed. In the low power state, the at least one processor 120 may analyze the first audio signal, based on the first sensing operation.

The at least one processor 120 may obtain a first audio signal while the electronic apparatus 100 operates in the low power state. The at least one processor 120 may change the low power state to a standby state, in the case where the electronic apparatus 100 is not in the ultrasonic wave-output impossible state.

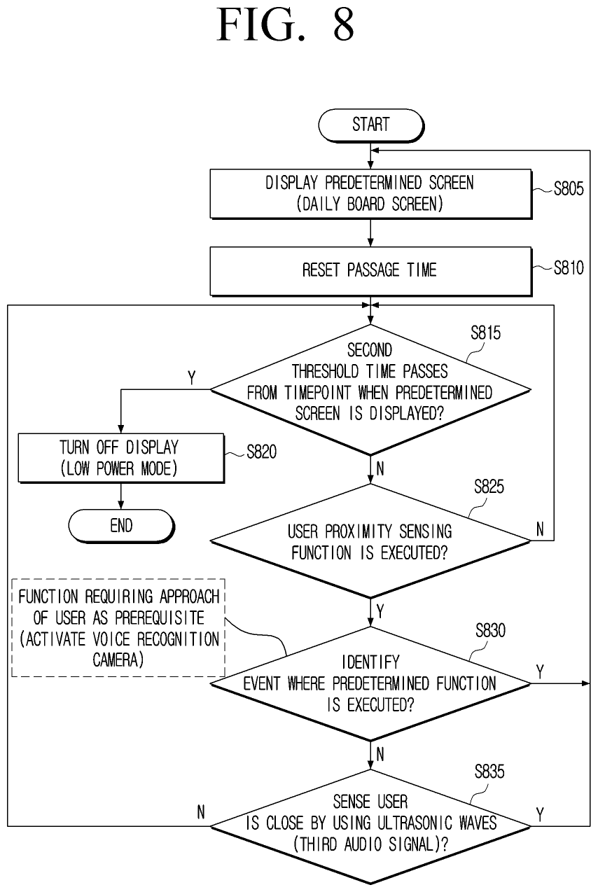

The low power state may denote a state in which a supply of power to at least part of the elements of the electronic apparatus 100 is cut off while a supply of power to the display 140 is cut off. The low power state may be a state in which the predetermined function is only performed. The low power state may be a state in which power is supplied only to a module that performs the predetermined function among a plurality of functions performed by the electronic apparatus 100. In the low power state. In one example, the low power state may be a state in which power is supplied only to perform the first sensing operation in FIG. 6. In the low power state, the second sensing operation and the third sensing operation described in FIG. 7 and FIG. 8 may not be performed.

The low power state may be a state in which the predetermined function is only performed. The low power state may be a state in which power is supplied only to a module that performs the predetermined function among a plurality of functions performed by the electronic apparatus 100. In one example, the low power state may be a state in which power is supplied only to perform the first sensing operation in FIG. 6. In the low power state, the second sensing operation and the third sensing operation described in FIG. 7 and FIG. 8 may not be performed.

The standby state may be a state in which partial functions may be limited while more functions may be performed than in the low power state. In the standby state, the second sensing operation and the third sensing operation may be performed. The standby state may be a state for displaying the predetermined screen. The electronic apparatus 100 in the standby state may supply power so that the predetermined screen is displayed on the display 140.

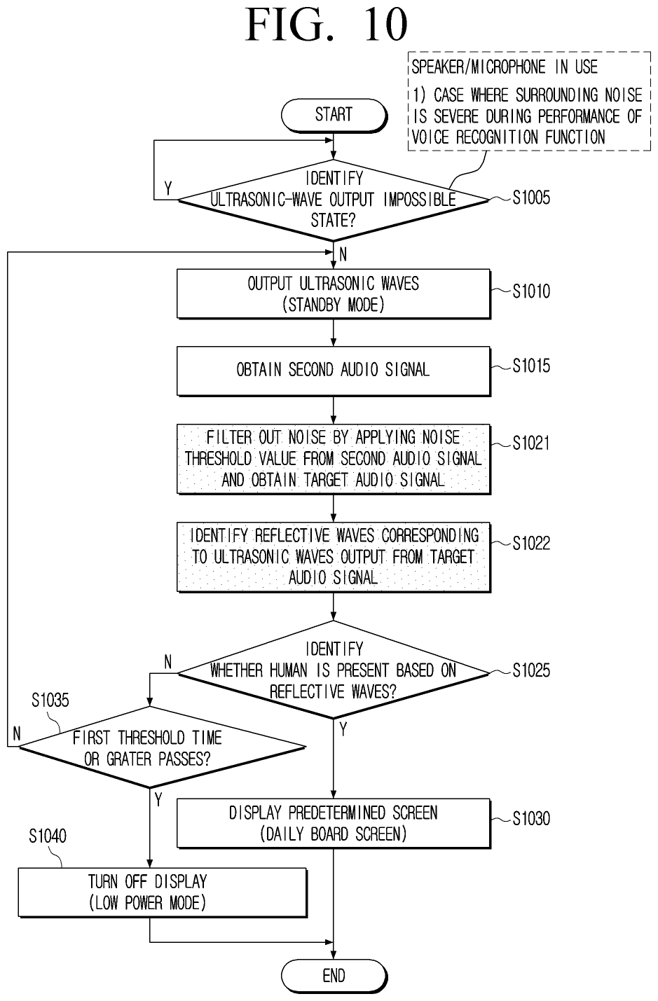

The at least one processor 120 may obtain a target audio signal by filtering out noise from the second audio signal, based on a noise threshold value that is stored previously. The at least one processor 120 may identify reflective waves corresponding to ultrasonic waves in the target audio signal. The at least one processor 120 may identify whether a user is present around the electronic apparatus 100, based on the ultrasonic waves and the reflective waves. Descriptions in relation to this are provided with reference to FIG. 10.

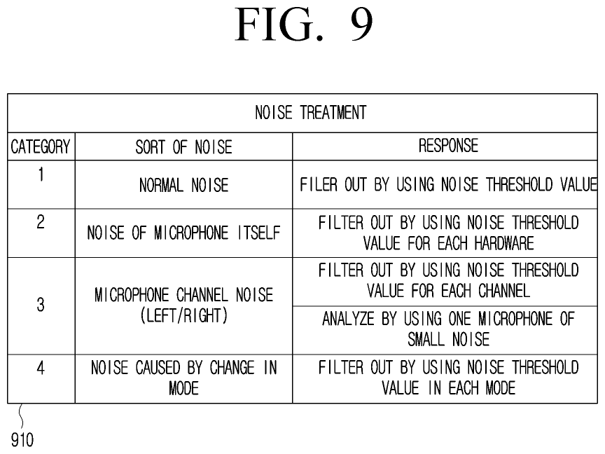

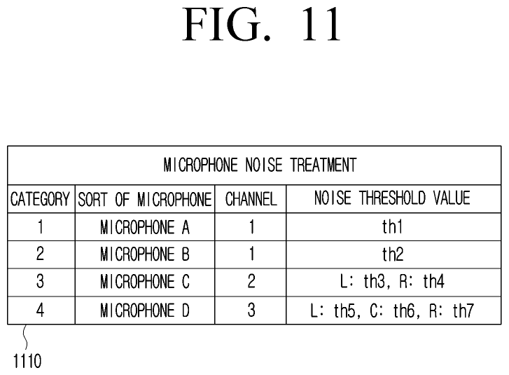

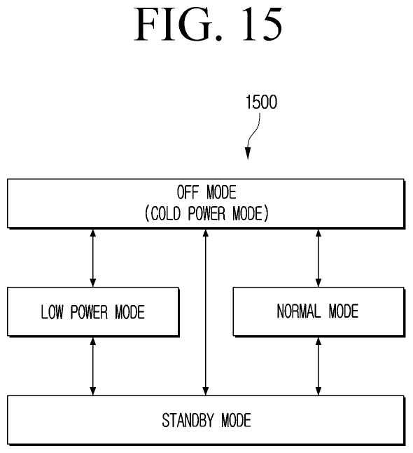

Detailed descriptions in relation to an operation of filtering out noise are provided with reference to FIGS. 9-18. A method of treating normal noise is described with reference to FIG. 10. A method of treating noise based on the properties of a microphone is described with reference to FIGS. 11-14. A method of treating noise depending on a change in a state is described with reference to FIGS. 15-18.

The at least one processor 120 may obtain a phase difference value based on a first phase of ultrasonic waves and a second phase of reflective waves. The at least one processor 120 may identify that a user is present around the electronic apparatus 100, when the phase difference value is equal to or greater than a phase threshold value.

The first phase may be a basis phase of ultrasonic waves that are output through the speaker 170. The first phase may be a predetermined value. The second phase may correspond to reflective waves. The reflective waves may denote a signal that is reflected by a human (user) or an object. In the case where ultrasonic waves are reflected, the phase may change. Accordingly, the first phase and the second phase may differ.

The at least one processor 120 may obtain a first phase of ultrasonic waves. The at least one processor 120 may extract (or identify) reflective waves from the second audio signal. The at least one processor 120 may obtain a phase difference value based on a difference value between the first phase and the second phase. The at least one processor 120 may identify whether the phase difference value is equal to or greater than a phase threshold value. The phase threshold value may be a value that indicates whether a user is close.

In the case where the phase difference value is equal to or greater than the phase threshold value, the at least one processor 120 may identify that a user is sensed around the electronic apparatus 100.

In the case where the phase difference value is less than the phase threshold value, the at least one processor 120 may identify that a user is not sensed around the electronic apparatus 100.

When identifying that a user is present around the electronic apparatus 100, the at least one processor 120 may control the display 140 to display a predetermined screen. The predetermined screen may include at least one of a time UI, a weather UI, a schedule UI, an indoor environment UI and/or a guide UI. Descriptions in relation to this are provided with reference to FIG. 5.

After displaying the predetermined screen, the at least one processor 120 may perform a third sensing operation. The third sensing operation may be an operation for determining whether a user is identified continuously around the electronic apparatus 100 in the state where the predetermined screen is displayed.

Particulars in relation to the third sensing operation are provided with reference to FIG. 8.

In the second sensing operation, ultrasonic waves may be first ultrasonic waves, and reflective waves may be first reflective waves. A phase difference value may be a first phase difference value.

Based on the third sensing operation, the at least one processor 120 may output second ultrasonic waves through the speaker 170 after displaying the predetermined screen. The at least one processor 120 may obtain a third audio signal including second reflective waves that correspond to the second ultrasonic waves through the microphone 180. In the case where it is identified that a user is present around the electronic apparatus 100 based on the third audio signal, the at least one processor 120 may control the display 140 such that the predetermined screen continues to be displayed.

The at least one processor 120 may identify whether a user continues to be sensed around the electronic apparatus 100. The at least one processor 120 may output the second ultrasonic waves through the speaker 170.

According to an embodiment, the first ultrasonic waves output in the second sensing operation and the second ultrasonic waves output in the third sensing operation may be identical.

According to an embodiment, the first ultrasonic waves output in the second sensing operation and the second ultrasonic waves output in the third sensing operation may be different.

After outputting the second ultrasonic waves, the at least one processor 120 may obtain a new third audio signal. The at least one processor 120 may determine whether a user is present around the electronic apparatus 100 based on the third audio signal. The third audio signal may include second reflective waves corresponding to the second ultrasonic waves. In the case where the user is still present, the phase of the second ultrasonic waves and the phase of the second reflective waves may be different.

The at least one processor 120 may obtain a third phase of the second ultrasonic waves. The at least one processor 120 may obtain a fourth phase of the second reflective waves. The at least one processor 120 may obtain a second phase difference value based on a difference value between the third phase and the fourth phase. The at least one processor 120 may determine whether the second phase difference value is equal to or greater than a phase threshold value.

In the case where the second phase difference value is equal to or greater than the phase threshold value, the at least one processor 120 may identify that a user is present around the electronic apparatus 100.

In the case where the second phase difference value is less than the phase threshold value, the at least one processor 120 may identify that a user is not present around the electronic apparatus 10.

The at least one processor 120 may sense a user by adjusting sensitivity. The at least one processor 120 may apply different sensitivity in the second sensing operation and the third sensing operation.

The at least one processor 120 may obtain a first average value of a first threshold number of phase difference values corresponding to first sensitivity from the second audio signal.

The at least one processor 120 may control the display 140 to display the predetermined screen in the case where the first average value is equal to or greater than the phase threshold value.

The at least one processor 120 may obtain a second average value of a second threshold number of phase difference values corresponding to second sensitivity from the third audio signal. The at least one processor 120 may control the display 140 not to display the predetermined screen in the case where the second average value is less than the phase threshold value.

The first threshold number may be greater than the second threshold number.

The second sensing operation may be an operation of sensing a user in the state where the predetermined screen is off. The third sensing operation may be an operation of sensing a user in the state where the predetermined screen is on.

The first sensitivity used in the second sensing operation may be less sensitive than the second sensitivity used in the third sensing operation. This is because waste of power may occur in the case where the predetermined screen is displayed due to an error despite the absence of a user.

The second sensitivity used in the third sensing operation may be more sensitive than the first sensitivity used in the second sensing operation. This is because inconvenience of a user may occur in the case where the predetermined screen displayed once is turned off due to an error.

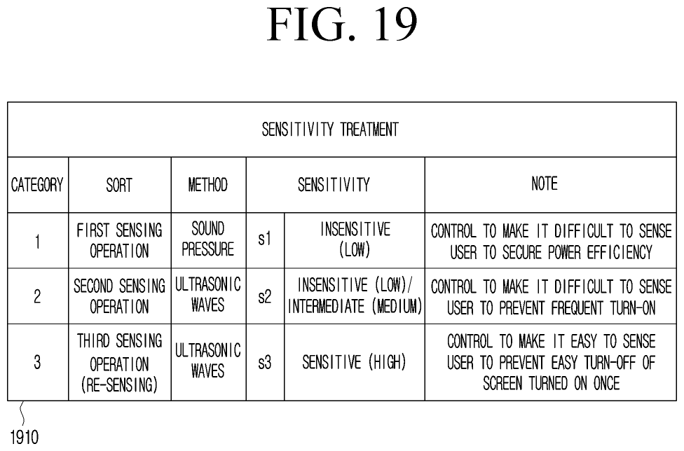

Descriptions in relation to sensitivity are provided with reference to FIGS. 19-22.

In the case where ultrasonic waves are output through the speaker 170 and reflective waves are received through the microphone 180, a separate ultrasonic sensor is not required. Operations performed to(or by) the electronic apparatus 100 may be also be applied to various types of apparatuses that do not include an ultrasonic sensor.

Even in the case where an ultrasonic sensor is used, a method of treating noise or a method of sensing a user and the like may be applied in the same way. In one example, the electronic apparatus 100 may include an ultrasonic sensor. The electronic apparatus 100 may output ultrasonic waves through the ultrasonic sensor. The electronic apparatus 100 may receive reflective waves through the ultrasonic sensor.

The electronic apparatus 100 may sense a user with high accuracy only by using the speaker 170 and the microphone 180, even without an ultrasonic sensor or a motion sensor. Any effect on animals or infants may be minimized by using the speaker 170 instead of an ultrasonic sensor. The performance of an operation of treating noise may secure high accuracy in sensing a user.

According to an embodiment, operations performed by the electronic apparatus 100 may all be performed by the electronic apparatus 100. All of the first sensing operation in FIG. 6, the second sensing operation in FIG. 7 and the third sensing operation in FIG. 8 may be performed by the electronic apparatus 100.

According to an embodiment, the second sensing operation and the third sensing operation may be performed by an external server while the first sensing operation is performed by the electronic apparatus 100. The electronic apparatus 100 may transmit the second audio signal (or third audio signal) to the external server. The external server may receive the second audio signal (or third audio signal) from the electronic apparatus 100. The external server may determine whether a user is present based on the second audio signal (or third audio signal) received. The external server may perform a noise filtering function in relation to the second audio signal (or third audio signal) received. Operations in FIGS. 9-18, which relate to a noise treating operation, may be performed by the external server in the same way.

According to an embodiment, the electronic apparatus 100 may sense a user by using Artificial Intelligence. The electronic apparatus 100 may store an artificial intelligence model. The electronic apparatus 100 may input an audio signal to the artificial intelligence model. The electronic apparatus 100 may obtain output data indicating results as to whether a user is sensed, based on the artificial intelligence model. The electronic apparatus 100 may display a user sensing-based predetermined screen based on the output data.

In one example, the artificial intelligence model may be a model that performs all of the first sensing operation, the second sensing operation and the third sensing operation.

In one example, the artificial intelligence model may be a model that performs the second sensing operation and the third sensing operation.

The electronic apparatus 100 may input, to the artificial intelligence model, the second audio signal (or third audio signal) that is obtained after output of ultrasonic waves. Based on the second audio signal (or third audio signal) input, the electronic apparatus 100 may obtain result data indicating whether a user is present around the electronic apparatus 100 as output data.

The electronic apparatus 100 may use Artificial Intelligence (AI) utilizing a machine learning algorithm.

As a computer system implementing human-level intelligence, an artificial intelligence system may be a system in which the more a machine learns, determines and is used, the more the recognition rate improves.

Artificial Intelligence technology may be composed of machine learning (deep learning) technology using an algorithm that classifies/learns the features of input data on its own, and element technologies for mimicking the functions of recognition, determination and the like of the human brain by using a machine learning algorithm.

The element technologies, for example, may include at least one of a linguistic understanding technology for recognizing languages/letters of the human, a visual understanding technology for recognizing an object like a visual sense of the human, an inference/prediction technology for determining information and making a logical inference and prediction, a knowledge expression technology for processing experience information of the human as knowledge data, and an operation control technology for controlling an autonomous travel of a vehicle and/or the movement of a robot.

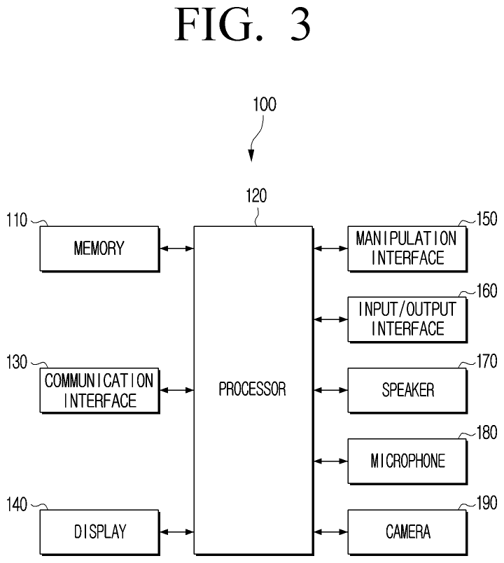

FIG. 3 is a block diagram provided to explain a specific configuration of the electronic apparatus of FIG. 2, according to an embodiment.

Referring to FIG. 3, the electronic apparatus 100 may include at least one of memory 110, at least one processor 120, a communication interface 130, a display 140, a manipulation interface 150, an input/output interface 160, a speaker 170, a microphone 180 and/or a camera 190.

The memory 110 may be implemented as internal memory such as ROM (e.g., electrically erasable programmable read-only memory (EEPROM)), RAM, and the like included in the at least one processor 120, or may be implemented as memory separate from the at least one processor 120. The memory 110 may be implemented in the form of memory embedded in the electronic apparatus 100 or in the form of memory detachable from the electronic apparatus 100 depending on a data storage purpose. For example, in the case of data for driving the electronic apparatus 100, the data may be stored in the memory embedded in the electronic apparatus 100, and in the case of data for an expansion function of the electronic apparatus 100, the data may be stored in memory detachable from the electronic apparatus 100.

The memory embedded in the electronic apparatus 100 may be implemented in the form of at least one of volatile memory (e.g., dynamic RAM (DRAM), static RAM (SRAM) or synchronous dynamic RAM (SDRAM), and the like) or non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash or NOR flash, and the like), hard drive, or solid state drive (SSD)), and the memory detachable from the electronic apparatus 100 may be implemented in the form of a memory card (e.g., a compact flash (CF), a secure digital (SD), a micro secure digital (Micro-SD), a mini secure digital (Mini-SD), an extreme digital (xD), a multi-media card (MMC), and the like), external memory connectable to a USB port (e.g., USB memory), or the like.

The memory 110 may store at least one instruction. Based on the instruction stored in the memory 110, the at least one processor 120 may perform a variety of operations.

The at least one processor 120 may be implemented as a digital signal processor (DSP) for processing digital signals, a microprocessor, or a time controller (TCON), but not limited thereto, and the at least one processor 120 may include one or more of a central processing unit (CPU), a micro controller unit (MCU), a micro processing unit (MPU), a controller, an application processor (AP), a graphics-processing unit (GPU), a communication processor (CP), and an ARM (advanced reduced instruction set computer (RISC) machines) processor, or may be defined as a corresponding term. The at least one processor 120 may be implemented in the form of a system on chip (SoC) with embedded processing algorithms, a large scale integration (LSI), or in the form of a field programmable gate array (FPGA). The at least one processor 120 may perform a variety of functions by executing computer executable instructions stored in the memory.

The communication interface 130 is an element that communicates with various types of external apparatuses, based on various types of communication methods. The communication interface 130 may include a wireless communication module or a wired communication module. Each communication module may be implemented in the form of at least one hardware chip.

The wireless communication module may be a module that communicates with an external apparatus wirelessly. For example, the wireless communication module may include at least one of a WiFi module, a Bluetooth module, an infrared communication module or other communication modules.

The WiFi module and the Bluetooth module may perform communication based on a WiFi method and a Bluetooth method respectively. In the case where the WiFi module or the Bluetooth module is used, various types of connection information such as a service set identifier (SSID), a session key and the like may be first transmitted and received, and are used to perform communication connection and then transmit and receive various types of information.

The infrared communication module performs communication based on an infrared Data Association (IrDA) communication technology which transmits data wirelessly over a short distance using infrared rays between optical light and millimeter waves.

In addition to the above-described communication methods, other communication modules may include at least one communication chip that performs communication according to various wireless communication standards such as Zigbee, 3rd Generation (3G), 3rd Generation Partnership Project (3GPP), Long Term Evolution (LTE), LTE Advanced (LTE-A), 4th Generation (4G), 5th Generation (5G) and the like.

A wired communication module may be a module that performs communication with an external apparatus via cable. For example, the wired communication module may include at least one of a local area network (LAN) module, an Ethernet module, pair cables, coaxial cables, fiber optic cables, or an Ultra Wide-Band (UWB) module.

According to an embodiment, the communication interface 130 may use an identical communication module (e.g., a WiFi module) to communicate with an external apparatus such as a remote control device and an external server.

According to an embodiment, the communication interface 130 may use a different communication module to communicate with an external apparatus such as a remote control device and an external server. For example, the communication interface 130 may use at least one of an Ethernet module or a WiFi module to communicate with an external server, and use a Bluetooth module to communicate with an external apparatus such as a remote control device. However, these are only provided as examples, and the communication interface 130 may use at least one communication module among various types of communication modules in the case where the communication interface 130 communicates with a plurality of external apparatuses or external servers.

The display 140 may be implemented as various types of displays such as a liquid crystal display (LCD), an organic light emitting diode (OLED) display, a plasma display panel (PDP) and the like. In the display 140, driving circuitry implemented in the form of an amorphous silicon thin film transistor (a-si TFT), a low temperature poly silicon (LTPS) TFT, an organic TFT (OTFT) and the like, a backlight unit and the like may be included together. The display 140 may be implemented as a touch screen coupled with a touch sensor, a flexible display, a three-dimensional (3D) display and the like. According to an embodiment, the display 140 may include a bezel housing a display panel as well as a display panel outputting an image. In particular, the bezel according to an embodiment may include a touch sensor for sensing a user interaction.

The manipulation interface 150 may be implemented as a device such as a button, a touch pad, a mouse and a keyboard, or implemented as a touch screen capable of performing the above-described display function and manipulation input function together. The button may be various types of buttons such as a mechanical button, a touch pad, a wheel and the like that are formed in any area such as the front, side, rear and the like of the exterior of the main body of the electronic apparatus 100.

The input/output interface 160 may be any one of a High-Definition Multimedia Interface (HDMI), a Mobile High-Definition Link (MHL), a Universal Serial Bus (USB), a Display Port (DP), a Thunderbolt, a Video Graphics Array (VGA) port, a RGB port, a D-subminiature (D-SUB), a Digital Visual Interface, (DVI). The input/output interface 160 may input/output at least one of an audio signal and a video signal. Depending on embodiments, the input/output interface 160 may include a port inputting/outputting an audio signal only and a port inputting/outputting a video signal only as an individual port, or be implemented as one port inputting/outputting both of an audio signal and a video signal. The electronic apparatus 100 may transmit, to an external apparatus (e.g., an external display device or an external speaker), at least one of audio and video signals through the input/output interface 160. An output port included in the input/output interface 160 may connect with an externa apparatus, and the electronic apparatus 100 may transmit at least one of audio and video signals to the external apparatus through the output port.

The input/output interface 160 may connect with the communication interface. The input/output interface 160 may transmit information received from an external device to the communication interface or transmit information received through the communication interface to an external device.

The speaker 170 may be an element that outputs various types of notification sounds or voice messages and the like as well as various types of audio data.

The microphone 180 is an element for receiving a user voice or another sound and converting the same into audio data. The microphone 180 may receive a user voice in an activated state. For example, the microphone 180 may be integrally formed in the directions of the upper side or front surface, lateral surface and the like of the electronic apparatus 100. The microphone 180 may include various types of elements such as a microphone collecting a user voice in an analogue form, amp circuitry amplifying the user voice collected, an A/D conversion circuitry sampling the user voice amplified and converting the same into a digital signal, and filter circuitry removing a noise component from the digital signal converted, and the like.

The camera 190 is an element for capturing an image of an object and generating a captured image, and the captured image includes both a moving image and a still image. The camera 190 may obtain an image of at least one external device, and may be implemented as a camera, a lens, an infrared sensor and the like.

The camera may include a lens and an image sensor. The sort of lenses may be categorized as an ordinary universal lens, a wide-angle lens, a zoom lens and the like, and may be determined depending on the sort, properties, usage environment and the like of an electronic apparatus 100. For the image sensor, a complementary metal oxide semiconductor (CMOS), a charge coupled device (CCD) and the like may be used.

According to an embodiment, the electronic apparatus 100 may include a display 140. The electronic apparatus 100 may display an obtained image or contents on the display 140 directly.

According to an embodiment, the electronic apparatus 100 may not include the display 140. The electronic apparatus 100 may connect with an external display device, and transmit the image or contents stored in the electronic apparatus 100 to the external display device.

The electronic apparatus 100 may transmit an image or contents to an external display device together with a control signal for controlling so that the image or contents are displayed on the external display device. The external display device may connect with the electronic apparatus 100 through the communication interface 130 or the input/output interface 160. For example, the electronic apparatus 100 may not include a display such as a set top box (STB).

The electronic apparatus 100 may only include a small-sized display capable of displaying brief information such as text information and the like. The electronic apparatus 100 may transmit an image or contents to an external display device in a wireless or wired manner through the communication interface 130 or to an external display device through the input/output interface 160.

There may be an example in which the electronic apparatus 100 performs an operation corresponding to a user voice signal received through the microphone 180.

According to an embodiment, the electronic apparatus 100 may control the display 140 based on the user voice signal received through the microphone 180. For example, when receiving a user voice signal for displaying contents A, the electronic apparatus 100 may control the display 140 to display content A.

According to an embodiment, the electronic apparatus 100 may control an external display device connecting to the electronic apparatus 100, based on a user voice signal received through the microphone 180. The electronic apparatus 100 may generate a control signal for controlling the external display device so that an operation corresponding to the user voice signal is performed by the external display device and transmit the generated control signal to the external display device. The electronic apparatus 100 may store a remote control application for controlling an external display device. Additionally, the electronic apparatus 100 may transmit the generated control signal to the external display device by using at least one of the Bluetooth, WiFi or infrared communication methods. For example, when receiving a user voice signal for displaying contents A, the electronic apparatus 100 may transmit, to the external display device, a control signal for controlling so that contents A are displayed on the external display device. The electronic apparatus 100 may denote various types of terminal devices such as a smartphone, an AI speaker and the like in which a remote control application is installable.

According to an embodiment, the electronic apparatus 100 may use a remote control device to control an external display device connecting with the electronic apparatus 100, based on a user voice signal received through the microphone 180. The electronic apparatus 100 may transmit, to the remote control device, a control signal for controlling the external display device so that an operation corresponding to the user voice signal may be performed by the external display device. Additionally, the remote control device may transmit the control signal received from the electronic apparatus 100 to the external display device. For example, when receiving a user voice signal for displaying contents A, the electronic apparatus 100 may transmit, to the remote display device, a control signal for controlling so that contents A may be displayed on the external display device, and the remote control device may transmit the received control signal to the external display device.

The electronic apparatus 100 may receive a user voice signal in various ways.

According to an embodiment, the electronic apparatus 100 may receive a user voice signal through the microphone 180 included in the electronic apparatus 100.

According to an embodiment, the electronic apparatus 100 may receive a user voice signal from an external apparatus including a mic. The external apparatus may denote a remote control device or a smartphone and the like. The user voice signal received may be a digital voice signal, but may be an analogue voice signal depending on embodiments. The electronic apparatus 100 may receive a user voice signal, based on a wireless communication method such as Bluetooth or WiFi and the like.

The electronic apparatus 100 may convert a user voice signal in various ways.

According to an embodiment, the electronic apparatus 100 may obtain text information corresponding to a user voice signal from an external server. The electronic apparatus 100 may transmit the user voice signal (an audio signal or a digital signal) to the external server. The external server may denote a voice recognition server. The voice recognition server may convert the user voice signal into text information by using speech to text (STT). Additionally, the external server may transmit the text information corresponding to the user voice signal converted to the electronic apparats 100.

According to an embodiment, the electronic apparatus 100 itself may obtain text information corresponding to a user voice signal. The electronic apparatus 100 may also apply the speech to text (STT) function to a digital voice signal directly, convert the digital voice signal into text information, and transmit the text information converted to an external server.

The external server may transmit information to the electronic apparatus 100 in various ways.

According to an embodiment, the external server may transmit text information corresponding to a user voice signal to the electronic apparatus 100. The external server may be a server performing a voice recognition function for converting a user voice signal into text information.

According to an embodiment, the external server may transmit, to the electronic apparatus 100, at least one of text information corresponding to a user voice signal or search result information corresponding to text information. The external server may be a server that performs a search result provision function of providing search result information corresponding to text information in addition to a voice recognition function of converting a user voice signal into text information. In one example, the external server may be a server that performs both the voice recognition function and the search result provision function. In another example, the external server may perform the voice recognition function only, and the search result provision function may be performed by a separate server. The external server may transmit text information to a separate server to obtain search results and obtain search results corresponding to the text information from the separate server.

The electronic apparatus 100 may communicably connect with an external apparatus and an external server in various ways.

According to an embodiment, a communication module may be implemented identically for communication with an external apparatus and an external server. For example, the electronic apparatus 100 may communicate with the external apparatus by using a Bluetooth module, while communicating with the external server by using the Bluetooth module.

According to an embodiment, a communication module for communicating with an external apparatus and an external server may be implemented separately. For example, the electronic apparatus 100 may communicate with the external apparatus by using a Bluetooth module, while communicating with the external server by using an Ethernet modem or a WiFi module.

FIG. 4 is a view provided to a three-stage operation for identifying whether a user is close, according to an embodiment.

Referring to FIG. 4, the electronic apparatus 100 may identify whether a user is close, based on a normal audio signal (S410). The normal audio signal may denote an audio signal that does not include ultrasonic waves. The normal audio signal may include signals only within an audible frequency range of a human. The normal audio signal may be a signal that is output without including signals of an ultrasonic band.

The electronic apparatus 100 may identify whether a user is present based on the normal audio signal. The electronic apparatus 100 may identify whether a user is close based on the normal audio signal. The electronic apparatus 100 may identify whether a user is present within a threshold distance from the electronic apparatus 100 based on the normal audio signal. The electronic apparatus 100 may identify whether a user approaches based on the normal audio signal. Whether a user approaches may indicate whether the user becomes close to the electronic apparatus 100 or whether the user becomes far away from the electronic apparatus 100.

In one example, the normal audio signal may be output through the speaker 170 of the electronic apparatus 100. S410 may be described as a first sensing operation.

In the case where it is identified that a user is close based on the normal audio signal (S410-Y), the electronic apparatus 100 may identify whether the user is close based on an ultrasonic audio signal (S420). The ultrasonic audio signal may denote an audio signal including ultrasonic waves. The ultrasonic audio signal may include signals of an ultrasonic band.

The electronic apparatus 100 may identify whether the user is present based on the ultrasonic audio signal. The electronic apparatus 100 may identify whether the user is close based on the ultrasonic audio signal. The electronic apparatus 100 may identify whether a user is present within a threshold distance from the electronic apparatus 100 based on the ultrasonic audio signal. The electronic apparatus 100 may identify whether a user approaches based on the ultrasonic audio signal. Whether a user approaches may indicate whether the user becomes close to the electronic apparatus 100 or whether the user becomes far away from the electronic apparatus 100.

In one example, the ultrasonic audio signal may be output through the speaker 170 of the electronic apparatus 100. S420 may be described as a second sensing operation.

When identifying that the user is close based on the ultrasonic audio signal (S420-Y), the electronic apparatus 100 may display a predetermined screen (S425). The predetermined screen may denote a screen in relation to a predetermined service (e.g., a daily board screen) that is provided by the electronic apparatus 100. The predetermined screen may be described as a home screen, a service screen, a home widget and the like that are provided to the user. Particulars in relation to the predetermined screen are provided with reference to FIG. 5.

After displaying the predetermined screen, the electronic apparatus 100 may identify whether the user is close based on the ultrasonic audio signal (S430). The ultrasonic audio signal may denote an audio signal including ultrasonic waves. The ultrasonic audio signal may include signals of the ultrasonic band.

The electronic apparatus 100 may identify whether a user is present based on the ultrasonic audio signal. The electronic apparatus 100 may identify whether a user is close based on the ultrasonic audio signal. The electronic apparatus 100 may identify whether a user is present within a threshold distance from the electronic apparatus 100 based on the ultrasonic audio signal. The electronic apparatus 100 may identify whether a user approaches based on the ultrasonic audio signal. Whether a user approaches may indicate whether the user becomes close to the electronic apparatus 100 or whether the user becomes far away from the electronic apparatus 100.

In one example, the ultrasonic audio signal maybe output through the speaker 170 of the electronic apparatus 100. S420) may be described as a third sensing operation.

When identifying that the user is close (S430-Y), the electronic apparatus 100 may perform S425 and/or S430. When identifying that the user is not close (S430-N), the electronic apparatus 100 may turn off the display 140. The electronic apparatus 100 may control the display 140 so that the display 140 may be turned off. The electronic apparatus 100 may operate in a low power state (a low power mode).

FIG. 5 is a view provided to explain a screen provided based on a predetermined event, according to an embodiment.

Referring to FIG. 5, the electronic apparatus 100 may display a predetermined screen 500 based on a predetermined event. The predetermined event may include at least one of an event in which a user is identified near the electronic apparatus 100, an event in which the movement of a user is identified, and/or an event in which the presence of a user is identified within a threshold distance from the electronic apparatus 100.

The predetermined screen 500 may include at least one information. The predetermined screen 500 may include at least one of time information 501, weather information 502, schedule information 503, indoor environment information 504 and/or guide information 505.

The time information may include current time and a current date.

The weather information may include weather corresponding to a current position of the electronic apparatus 100.

The schedule information may include a preregistered schedule corresponding to a current date. In one example, the schedule information may include birthday information.

The indoor environment information may include at least one of indoor temperature, indoor humidity and/or indoor illuminance in a space where the electronic apparatus 100 is disposed.

The guide information my include information for guiding a specific operation to the user. In one example, the guide information may include a guide operation for changing a bookmark item, and/or a guide operation for connecting with an external apparatus.

FIG. 6 is a view provided to explain a first sensing operation, according to an embodiment.

Referring to FIG. 6, the electronic apparatus 100 may turn off the display 140 (S605). In the case where the electronic apparatus 100 operates in a low power state (a low power mode), the display 140 may be turned off. The low power state may denote a state in which a supply of power to at least part of the elements of the electronic apparatus 100 is cut off while a supply of power to the display 140 is cut off. This does not mean that no element of the electronic apparatus 100 is provided with power during the low power state. During the low power operation, the electronic apparatus 100 may perform a function of sensing the proximity of the user.

In the state where the display 140 is off, the electronic apparatus 100 may identify whether the user's proximity sensing function is being executed (S610). The proximity sensing function maybe a function of identifying whether a user is present around the electronic apparatus 100. The proximity sensing function may be a function of performing the first sensing operation, the second sensing operation and/or the third sensing operation. The proximity sensing function may be performed according to user settings. Based on input of the user who executes the proximity sensing function, the electronic apparatus 100 may activate the proximity sensing function. Based on input of the user who does not execute the proximity sensing function, the electronic apparatus 100 may inactivate the proximity sensing function.

In the case where the user's proximity sensing function is being executed (S610-Y), the electronic apparatus 100 may obtain a first audio signal (S615). The electronic apparatus 100 may obtain the first audio signal through the microphone 180. The electronic apparatus 100 may perform a recording function through the microphone 180. The electronic apparatus 100 may obtain a first audio signal including a surrounding sound through the microphone 180. The electronic apparatus 100 may identify whether the user is present by analyzing the first audio signal.

The electronic apparatus 100 may determine whether predetermined sound pressure or greater is identified from the first audio signal (S610).

In one example, the electronic apparatus 100 may determine whether the predetermined sound pressure or greater is identified from the first audio signal.

In one example, the electronic apparatus 100 may obtain average sound pressure of the first audio signal. The electronic apparatus 100 may identify whether the average sound pressure is equal to or greater than the predetermined sound pressure.

In the case where the predetermined sound pressure is not identified from the first audio signal (S620-N), the electronic apparatus 100 may obtain a new audio signal.

In the case where the predetermined sound pressure is identified from the first audio signal (S620-Y), the electronic apparatus 100 may determine whether a predetermined sound is identified from the first audio signal (S625).

The predetermined sound may include at least one of a human voice, a sound made by a human, and/or a sound indicating that a human becomes close to the electronic apparatus 100. The predetermined sound is not limited to the above sounds.

When the predetermined sound is not identified from the first audio signal (S625-N), the electronic apparatus 100 may obtain a new audio signal.

When the predetermined sound is identified from the first audio signal (S625-Y), the electronic apparatus 100 may sense whether a user is close by using ultrasonic waves (a second sensing operation) (S630). The electronic apparatus 100 may operate in a standby state (or a standby mode) to perform the second sensing operation.

FIG. 7 is a view provided to explain a second sensing operation, according to an embodiment.

Referring to FIG. 7, when identifying that a user is close based on the first sensing operation, the electronic apparatus 100 may perform the second sensing operation.

The electronic apparatus 100 may identify whether the electronic apparatus 100 is in a state where output of ultrasonic waves is impossible (S705). The ultrasonic wave-output impossible state may be described as an ultrasonic wave-output impossible event.

According to an embodiment, the ultrasonic wave-output impossible state may include a state in which at least one of the speaker 170 or the microphone 180 is currently activated.

In the case where the speaker 170 is activated, it may be difficult to output specific ultrasonic waves. In the case where the speaker 170 is activated, the user may be using the electronic apparatus 100 currently. In the case where the microphone 180 is activated, it may be difficult to receive reflective waves corresponding to ultrasonic waves. In the case where the microphone 180 is activated, the user may be using the electronic apparatus 100 currently.

In one example, in the case where a voice recognition function is performed, the electronic apparatus 100 may determine that the speaker 170 or the microphone 180 is activated.

In one example in the case where the electronic apparatus 100 displays contents through the display 140, the electronic apparatus 100 may determine that the speaker 170 is activated.

According to an embodiment, the ultrasonic wave-output impossible state may a state in which the predetermined sound pressure or greater is identified in the ultrasonic band. In the second sensing operation, sound pressure in the ultrasonic band needs to be output. In the case where the predetermined sound pressure is already being output in the ultrasonic band around the electronic apparatus 100, the accuracy of the second sensing operation may decrease.

The electronic apparatus 100 may obtain average sound pressure of the ultrasonic band from a first audio signal that is obtained in the state where the electronic apparatus 100 does not output ultrasonic waves. When the average sound pressure of the ultrasonic band is equal to or greater than the predetermined sound pressure, the electronic apparatus 100 may determine that the electronic apparatus 100 is currently in the state where output of ultrasonic waves is impossible.

The predetermined sound pressure described in S705 and the predetermined sound pressure described in S620 of FIG. 6 may differ. To distinguish the predetermined sound pressures, the predetermined sound pressure in S620 of FIG. 6 may be described as first threshold sound pressure. The predetermined sound pressure in S705 may be described as second threshold sound pressure.

When the state where output of ultrasonic waves is impossible is identified (S705-Y), the electronic apparatus 100 may output ultrasonic waves (S710). The electronic apparatus 100 may operate in a standby state (or standby mode). The electronic apparatus 100 may output ultrasonic waves while the electronic apparatus 100 is operating in the standby state. In one example, the electronic apparatus 100 may output ultrasonic waves through the speaker 170. The electronic apparatus 100 may output audio signals including ultrasonic waves. The ultrasonic waves output may be a signal that is stored previously to identify whether a user is close.

After outputting the ultrasonic waves, the electronic apparatus 100 may obtain a second audio signal (S715). The electronic apparatus 100 may obtain the second audio signal through the microphone 180. The electronic apparatus 100 may perform a recording function through the microphone 180 for predetermined time from a timepoint when the ultrasonic waves are output. The electronic apparatus 100 may obtain the second audio signal by performing the recording function.

The electronic apparatus 100 may identify whether a user is present based on the second audio signal. The electronic apparatus 100 may identify reflective waves corresponding to ultrasonic waves from the second audio signal (S720). The ultrasonic waves may be ultrasonic waves that are output by the electronic apparatus 100 in S710. The ultrasonic waves may be described as output ultrasonic waves. The ultrasonic waves output in S710 may be reflected by a human. The electronic apparatus 100 may identify the ultrasonic waves (reflective waves) reflected by the human to identify whether the human is present.

When identifying whether the human is present based on the reflective waves (S725-Y), the electronic apparatus 100 may display a predetermined screen (S730). The predetermined screen is described with reference to FIG. 5.

In the case where it is not identified whether the human is present based on the reflective waves (S725-N), the electronic apparatus 100 may identify whether first threshold time passes (S735). The electronic apparatus 100 may identify whether the first threshold time passes from the timepoint when the ultrasonic waves are output.

In the case where the first threshold time does not pass (S735-N), the electronic apparatus 100 may perform S710-S735.

As the first threshold time passes (S735-Y), the electronic apparatus 100 may turn off the display 140 (S740). The electronic apparatus 100 may change the state of the electronic apparatus 100 to the low power state (or low power mode) from the standby state (or standby mode) in which the electronic apparatus 100 operates to output ultrasonic waves. In a specific embodiment, S740 may be omitted. If the second sensing operation is performed in the state where the display 140 is off, S740 may not be performed since the display 140 is already off. S740 relates to a third sensing operation. Descriptions in relation to this are provided with reference to FIG. 8.

FIG. 8 is a view provided to explain a third sensing operation, according to an embodiment.

Referring to FIG. 8, the electronic apparatus 100 may calculate passage time to determine whether to display the predetermined screen continuously.

The electronic apparatus 100 may display a predetermined screen (S805). As the predetermined screen is displayed, the electronic apparatus 100 may reset the passage time (S810).

The electronic apparatus 100 may identify whether a second threshold time passes from the timepoint when the predetermined screen is displayed (S815). As the second threshold time passes (S815-Y), the electronic apparatus 100 may turn off the display 140 (S820). The electronic apparatus 100 may operate in the low power state (or low power mode).

Unless the second threshold time passes (S815-N), the electronic apparatus 100 may identify whether the user's proximity sensing function is being performed (S825). In the case where the user's proximity sensing function is not being performed (S825-N), the electronic apparatus 100 may repeat S815 and/or S825 until the second threshold time passes. As the second threshold time passes, the electronic apparatus 100 may turn off the display 140.

In the case where the user's proximity sensing function is being performed (S825-Y), the electronic apparatus 100 may determine whether an event where a predetermined function is being performed is identified (S830). The event in which a predetermined function is being performed may include an event indicating that a user is using the electronic apparatus 100. The event in which a predetermined function is being performed may include an event in which a function requiring the approach of a user as a prerequisite is performed. In one example, the predetermined function may include at least one of a voice recognition function and/or a camera photographing function.

When identifying the event in which the predetermined function is being performed (S830-Y), the electronic apparatus 100 may display a predetermined screen continuously and reset passage time.

When not identifying the event in which the predetermined function is being performed (S830-N), the electronic apparatus 100 may identify whether a user is sensed by using ultrasonic waves (S835). S835 may be described as a third sensing operation. The third sensing operation may be identical with the second sensing operation. The third sensing operation may correspond to S705, S710, S715, S720, S725, S730, S735 and S745 in FIG. 7. To distinguish an audio signal obtained in the third sensing operation from an audio signal obtained in the second sensing operation, the second audio signal may be described as a third audio signal.

The second sensing operation may an operation of sensing a user in the state where the predetermined screen is not displayed. The third sensing operation may be an operation of sensing a user in the state where the predetermined screen is displayed.

FIG. 9 is a view provided to explain an operation of treating noise, according to an embodiment.

Referring to FIG. 9, the electronic apparatus 100 may treat noise in relation to an audio signal received. The electronic apparatus 100 may perform various noise treatment operations based on a cause of the occurrence of noise. The electronic apparatus 100 may store noise treatment information 910. The noise treatment information may include information indicating an operation of the electronic apparatus 100 for filtering out noise.

The electronic apparatus 100 may filter out noise by using a noise threshold value. Descriptions in relation to this are provided with reference to FIG. 10.

In one example, in the case where noise occurs in a normal situation, the electronic apparatus 100 may filter out noise by using the noise threshold value.

In one example, in the case where the occurrence of noise is caused by properties of the hardware of the microphone 180, the electronic apparatus 100 may filter out noise by using a noise threshold value corresponding to the properties of the hardware. Descriptions in relation to this are provided with reference to FIG. 11.

In one example, in the case where noise occurs in relation to channels of the microphone 180, the electronic apparatus 100 may filter out noise by using a noise threshold value corresponding to each of the channels of the microphone 180. The electronic apparatus 100 may perform the user's proximity sensing function only by using a microphone corresponding to one of a plurality of channels. Descriptions in relation to this are provided with reference to FIGS. 11-14.

In one example, in the case where noise occurs at a time of change in a state, the electronic apparatus 100 may filter out noise by using a noise threshold value based on each state. Descriptions in relation to this are provided with reference to FIGS. 15-18.

FIG. 10 is view provided to explain an operation of treating normal noise, according to an embodiment.

S1005, S1010, S1015, S1025, S1030, S1035 and S1040 in FIG. 10 may correspond to S705, S710, S715, S725, S730, S735 and S740 in FIG. 7. Repetitive description is avoided.

When obtaining the second audio signal, the electronic apparatus 100 may filter out noise from the second audio signal by applying a noise threshold value and obtain a target audio signal (S1021). The electronic apparatus 100 may filter out the noise from the second audio signal, based on the noise threshold value. The noise threshold value may be a predetermined value. The noise threshold value may denote a frequency component indicating noise. The electronic apparatus 100 may filter out (or remove) noise from the second audio signal, with the noise threshold value, and obtain a target audio signal. The target audio signal may be a signal that is obtained after the noise filtering function is performed.

The electronic apparatus 100 may identify reflective waves corresponding to ultrasonic waves, based on the target audio signal (S1022). The electronic apparatus 100 may identify reflective waves corresponding to ultrasonic waves (output) from the target audio signal from which the noise is filtered out. Then the electronic apparatus 100 may perform S1025, S1030, S1035, and S1040.

FIG. 11 is a view provided to explain an operation of treating noise caused by a microphone, according to an embodiment.

Referring to FIG. 11, the electronic apparatus 100 may treat the noise of a microphone. The electronic apparatus 100 may store microphone noise threshold value information 1110 including a noise threshold value that is different for each microphone. In the case where the microphone is implemented as/with a plurality of channels, the microphone noise threshold value information 1110 may include a noise threshold value corresponding to each of the channels.

In one example, a first microphone A may be one channel. The electronic apparatus 100 may store a noise threshold value th1 corresponding to the first microphone A.

In one example, a second microphone B may be one channel. The electronic apparatus 100 may store a noise threshold value th2 corresponding to the second microphone B. The noise threshold value th1 and the noise threshold value th2 may be identical or different.

In one example, a third microphone C may be two channels. The electronic apparatus 100 may store a noise threshold value th3 and th4 corresponding to each channel L and R of the third microphone C. A noise threshold value corresponding to a first channel L may be th3, while a noise threshold value corresponding to a second channel R may be th4. The noise threshold values th3 and th4 may be identical or different.

In one example, a fourth microphone D may be three channels. The electronic apparatus 100 may store a noise threshold value th5, th6 and th7 corresponding to each channel L, C and R of the fourth microphone D. A noise threshold value corresponding to a first channel L may be th5, a noise threshold value corresponding to a second channel C may be th6, and a noise threshold value corresponding to a third channel R may be th7. At least a part of the noise threshold values th5, th6 and th7 may be identical or different.

The electronic apparatus 100 may apply a different noise threshold value to each microphone 180, based on microphone noise threshold value information 1110.

The electronic apparatus 100 may obtain identification information of the microphone 180. The electronic apparatus 100 may obtain a noise threshold value corresponding to the identification information of the microphone 180, among a plurality of noise threshold values included in the microphone noise threshold value information 1110.

The electronic apparatus 100 may obtain a target audio signal based on the noise threshold value obtained. The electronic apparatus 100 may determine whether a user is close based on the target audio signal.

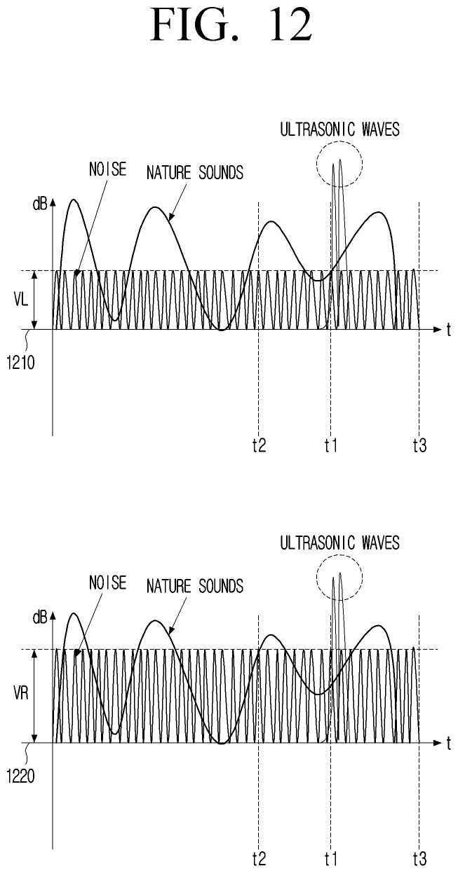

FIG. 12 is a view provided to explain noise and ultrasonic waves, according to an embodiment.

The electronic apparatus 100 may include a microphone 180 having two channels L and R.

Referring to an embodiment 1210 in FIG. 12, the electronic apparatus 100 may obtain an audio signal that is obtained from the microphone L of a first channel. The audio signal may include noise.

The electronic apparatus 100 may extract noise from the audio signal. The electronic apparatus 100 may obtain the size of the noise extracted. The audio signal may further include nature sounds, ultrasonic waves and the like as well as noise. The electronic apparatus 100 may extract the noise from the audio signal and identify (or calculate) the size of the noise.

In one example, the electronic apparatus 100 may obtain the size of the noise as VL, based on an audio signal obtained from the microphone L of the first channel.

Referring to an embodiment 1220 in FIG. 12, the electronic apparatus 100 may obtain an audio signal that is obtained from the microphone R of a second channel. The audio signal may include noise. The operation of extracting noise and calculating the size of the noise may be identical with that of the embodiment 1210 in FIG. 12.

In one example, the electronic apparatus 100 may obtain the size of the noise as VR, based on an audio signal obtained from the microphone R of the second channel.

The size of the noise VL may be less than the size of the noise VR. Since the performance of hardware may differ depending on each channel, the size of noise may differ depending on each channel. The electronic apparatus 100 may identify whether the proximity of a user is sensed, based on a microphone L corresponding to a channel the noise size of which is identified as being small, among the plurality of channels.

An audio signal may include a signal in relation to reflective waves corresponding to ultrasonic waves output in S710 in FIG. 7. The electronic apparatus 100 may obtain a timepoint t1 identified by the reflective waves. The electronic apparatus 100 may identify the size of noise, based on a threshold time range t2-t3 with reference to the timepoint t1 identified by the reflective waves. The operation of identifying the size of noise may be performed in relation to each of the audio signal obtained from the microphone L of the first channel and the audio signal obtained from the microphone R of the second channel.

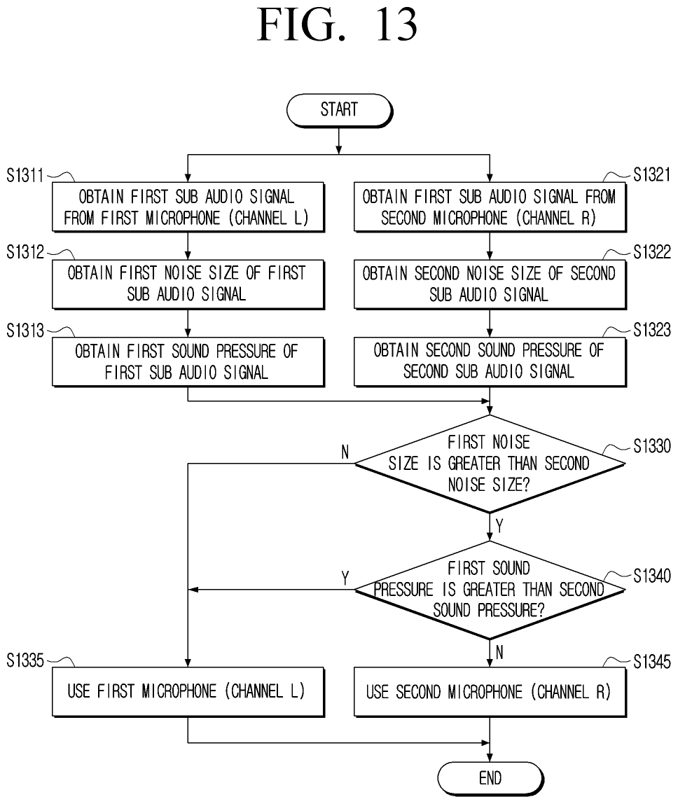

FIG. 13 is a view provided to explain an operation of selecting one microphone from a two-channel microphone, according to an embodiment.

Referring to FIG. 13, the electronic apparatus 100 may obtain a first sub audio signal from the first microphone (channel L) (S1311). The electronic apparatus 100 may extract noise from the first sub audio signal. The electronic apparatus 100 may obtain a first noise size of the first sub audio signal, based on the extracted noise (S1312). The electronic apparatus 100 may obtain first sound pressure of the first sub audio signal (S1313). The first sound pressure may denote average sound pressure of the first sub audio signal.

The electronic apparatus 100 may obtain a second sub audio signal from the second microphone (channel R) (S1321). The electronic apparatus 100 may extract noise from the second sub audio signal. The electronic apparatus 100 may obtain a second noise size of the second sub audio signal, based on the extracted noise (S1322). The electronic apparatus 100 may obtain second sound pressure of the second sub audio signal (S1323). The second sound pressure may denote average sound pressure of the second sub audio signal.

The sound pressure (first sound pressure, second sound pressure) may include components of a variety of sounds as well as noise. The noise size may denote the size of a noise component only. The sound pressure may denote the size of a variety of components included in an audio signal. In the embodiments of FIG. 12, the sound pressure may denote average sound pressure of an audio signal including all of the noise, nature sounds, ultrasonic waves and the like.

The electronic apparatus 100 may identify whether the first noise size is greater than the second noise size (S1330). In the case where the first noise size is not greater than the second noise size (S1330-N), the electronic apparatus 100 may perform the user's proximity sensing function by using the first microphone (channel L) (S1335). The electronic apparatus 100 may perform the second sensing operation or/to the third sensing operation by using the first microphone (channel L).

In the case where the first noise size is greater than the second noise size (S1330-Y), the electronic apparatus 100 may identify whether the first sound pressure is greater than the second sound pressure (S1340). In the case where the first sound pressure is greater than the second sound pressure (S1340-Y), the electronic apparatus 100 may perform the user's proximity sensing function by using the first microphone (channel L) (S1335). The electronic apparatus 100 may perform the second sensing operation or/to the third sensing operation by using the first microphone (channel L).

In the case where the first sound pressure is not greater than the second sound pressure (S1340-N), the electronic apparatus 100 may perform the user's proximity sensing function by using the second microphone (channel R) (S1345). The electronic apparatus 100 may perform the second sensing operation or/to the third sensing operation by using the second microphone (channel R).

According to an embodiment, the noise size may be described as noise sound pressure.

According to an embodiment, the noise size may a frequency range or a ratio of a signal to noise.

According to an embodiment, the electronic apparatus 100 may perform the user's proximity sensing function by using one of the plurality of microphones, only based on the noise size.

According to an embodiment, the electronic apparatus 100 may perform the user's proximity sensing function by using one of the plurality of microphones, only based on the sound pressure.

The electronic apparatus 100 may perform the user's proximity sensing function by using a microphone of a small noise size or highly measured sound pressure.

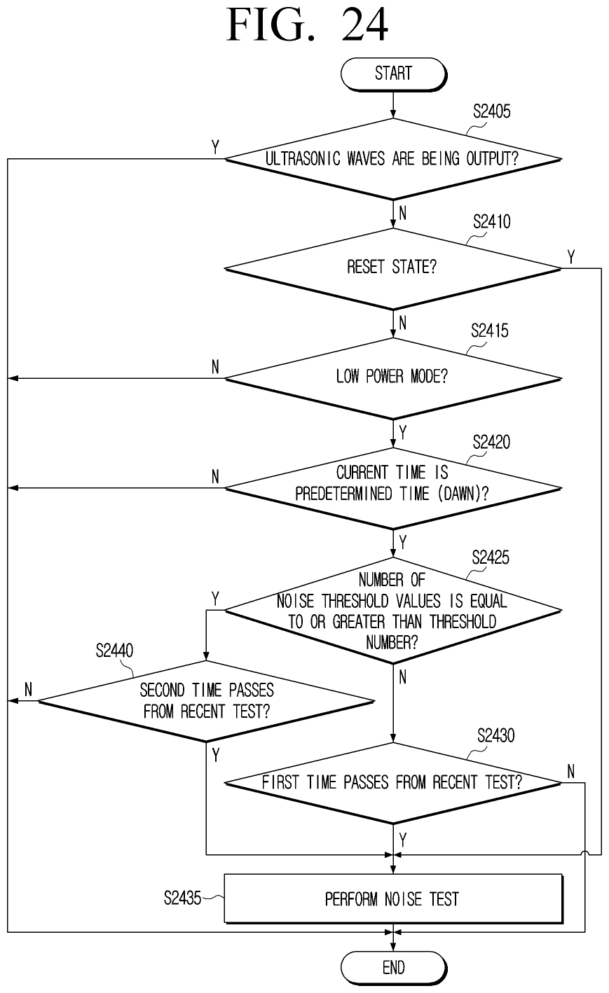

The embodiment of FIG. 13 may be applied in a test process in the same way. Descriptions of the test process are provided with reference to FIGS. 24-29.

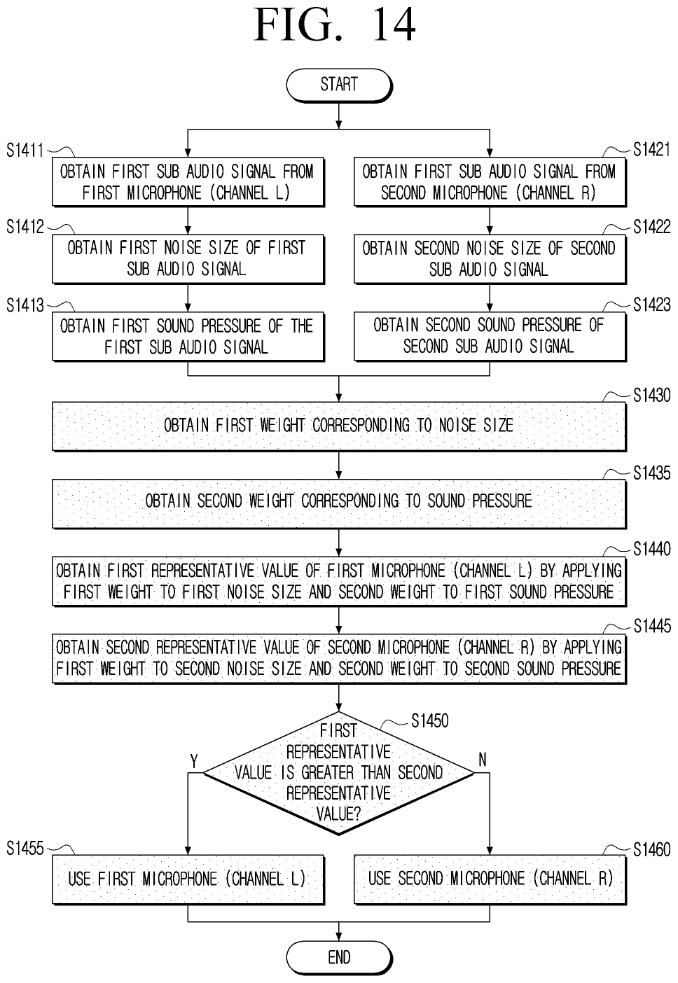

FIG. 14 is a view provided to explain an operation of selecting one microphone from a two-channel microphone, according to an embodiment.

S1411, S1412, S1413, S1421, S1422 and S1423 in FIG. 14 may correspond to S1311, S1312, S1313, S1321, S1322 and S1323 in FIG. 13. Repetitive description is avoided.

The electronic apparatus 100 may obtain a first weight corresponding to noise size (S1430). The electronic apparatus 100 may obtain a second weight corresponding to sound pressure (S1435). The first weight value and the second weight may differ. A scaling coefficient may be included in each weight. A scaling coefficient applied to each weight may differ. As the noise size becomes smaller and the sound pressure becomes higher, the audio signal may be analyzed more accurately. In one example, a first scaling coefficient included in the first weight may be a negative number, and a second scaling coefficient included in the second weight may be a positive number.

The electronic apparatus 100 may apply the first weight to the first noise size and the second weight to the first sound pressure, to obtain a first representative value of the first microphone (channel L) (S1440).

The electronic apparatus 100 may apply the first weight to the second noise size and the second weight to the second sound pressure, to obtain a second representative of the second microphone (channel R) (S1445).

The electronic apparatus 100 may compare the first representative value with the second representative value. The electronic apparatus 100 may determine whether the first representative value is greater than the second representative value (S1450). In the case where the first representative value is greater than the second representative value (S1450-Y), the electronic apparatus 100 may perform the user's proximity sensing function by using the first microphone (channel L) (S1455). The electronic apparatus 100 may perform the second sensing operation or/to the third sensing operation by using the first microphone (channel L).

In the case where the first representative value is not greater than the second representative value (S1450-N), the electronic apparats 100 may perform the user's proximity sensing operation by using the second microphone (channel R) (S1460). The electronic apparatus 100 may perform the second sensing operation or/to the third sensing operation by using the second microphone (channel R).

FIG. 15 is a view provided to explain a plurality of states in which an electronic apparatus operates, according to an embodiment.

Referring to an embodiment 1500 of FIG. 15, the electronic apparatus 100 may operate in one of an off state (or off mode), a low power state (or low power mode), a standby state (or standby mode) and a normal state (or normal mode).

The off mode may denote a mode in which the power of the electronic apparatus 100 is cut, and the off mode may be a mode in which power required for performing the remaining functions is cut except for a function of receiving an instruction for turning on power.

The low power mode may be a mode in which a predetermined function is only performed. The low power mode may be a mode in which power is supplied only to a module that performs a predetermined function among a plurality of functions performed by the electronic apparatus 100. In one example, the low power mode may be a mode in which power is supplied only to the function of performing the first sensing operation of FIG. 6. In the low power mode, the second sensing operation and the third sensing operation described in FIGS. 7 and 8 may not be performed.

The standby mode may be a mode in which more functions may be performed than in the low power mode but some functions may be limited. In the standby mode, the second sensing operation and the third sensing operation may be performed. The standby mode may be a mode for displaying a predetermined screen. The electronic apparatus 100 may supply power so that the predetermined screen may be displayed on the display 140 in the standby mode.

The normal mode may be a mode in which all the functions of the electronic apparatus 100 are performed. The electronic apparatus 100 may supply power according to a user instruction or a predetermined control instruction.

According to an embodiment, the first sensing operation may be performed even in the standby mode.

According to an embodiment, the first sensing operation, the second sensing operation, the third sensing operation and the like may be performed even in the normal mode.

With reference to power consumption, a first electricity amount may be consumed in the low-poser mode, a second electricity amount may be consumed in the standby mode, and a third electricity amount may be used in the normal mode. The second electricity amount may be greater than the first electricity amount. The third electricity amount may be greater than the second electricity amount.

The electronic apparatus 100 may change a mode under predetermined conditions. The mode may change based on predetermined conditions or user input. In the case of a change in the mode, there may be a change in the supply of power. A change in the configuration of hardware of the electronic apparatus 100 to which power is supplied may lead to the occurrence of noise.

In one example, the mode may change from the off mode to the low power mode, and change from the low power mode to the standby mode. An audio signal recorded in the standby mode may include noise.

In one example, the mode may change from the off mode to the normal mode, and change from the normal mode to the standby mode. An audio signal recorded in the standby mode may include noise.

In one example, the mode may change from the off mode to the standby mode. An audio signal recorded in the standby mode may include noise.

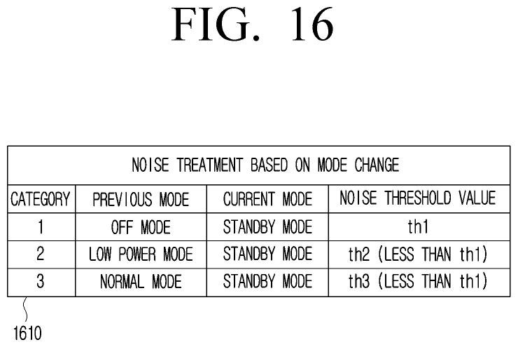

FIG. 16 is a view provided to explain an operation of treating noise based on a change in a state, according to an embodiment.

Referring to FIG. 16, the electronic apparatus 100 may store noise treatment information 1610 based on a change in the state (or mode). The noise treatment information 1610 based on a change in the state may include a noise threshold value corresponding to an event in relation to the change in the state. Noise may differ depending on a change in the state. The electronic apparatus 100 may apply a different noise threshold value, depending on a process of changing a state.

In one example, in the case where the mode changes from the off mode to the standby mode, the electronic apparatus 100 may determine the noise threshold value as a first threshold value th1.

In one example, in the case where the mode changes from the low power mode to the standby mode, the electronic apparatus 100 may determine the noise threshold value as a second threshold value th2.

In one example, in the case where the mode changes from the normal mode to the standby mode, the electronic apparatus 100 may determine the noise threshold value as a third threshold value th3.

A noise size occurring in the case where the mode changes from the off mode to the standby mode may be greater than a noise size occurring in the case where the mode changes from the low power mode to the standby mode.

The noise size occurring in the case where the mode changes from the off mode to the standby mode may be greater than noise size occurring in the case where the mode changes from the normal mode to the standby mode.

The second threshold value th2 and the third threshold value th3 may be less than the first threshold value th1. The electronic apparatus 100 may obtain a noise threshold value corresponding to a change in the mode, based on the noise treatment information 1610 based on the change in the mode.

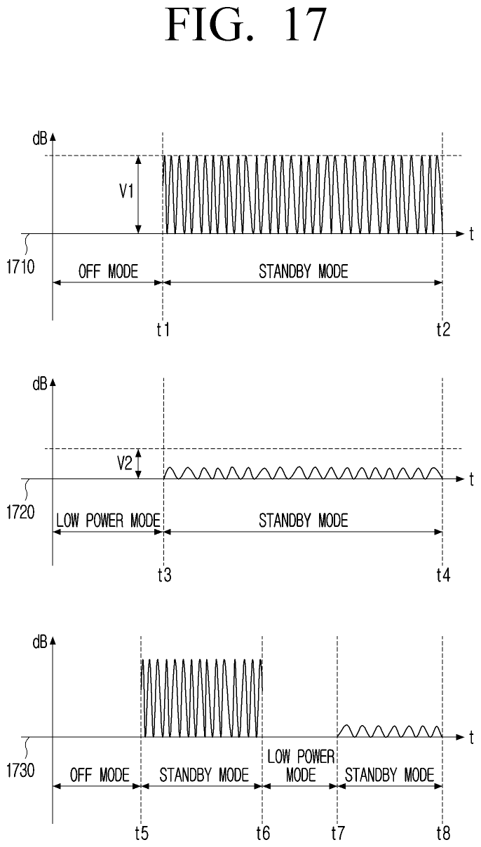

FIG. 17 is a view provided to explain noise based on a change in a state, according to an embodiment.

Referring to an embodiment 1710 of FIG. 17, noise occurring in the case where the state changes from the off state to the standby state is illustrated. In the embodiment 1710, the size of noise occurring in the standby state may be V1.

Referring to an embodiment 1720 of FIG. 17, noise occurring in the case where the state changes from the low power state to the standby state is illustrated. In the embodiment 1720, the size of noise occurring in the standby state may be V2.

The noise size V1 occurring in the case where the state changes from the off state to the standby state may be greater than the noise size V2 occurring in the case where the state changes from the normal state to the standby state.

Referring to an embodiment 1730 of FIG. 17, noise occurring in the cases where the state changes from the off state to the standby state, the state changes from the standby state to the low power state, and the state changes from the low power state to the standby state is illustrated. Although an audio signal is obtained in the standby state in the same way, the size of noise may be calculated differently depending on a previous state. When performing the second sensing operation or the third sensing operation in the standby state, the electronic apparatus 100 may use the noise threshold value differently depending on a previous state.

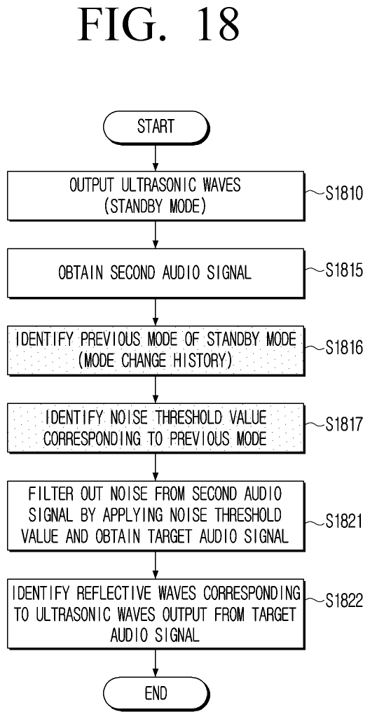

FIG. 18 is a view provided to explain an operation of treating noise based on a change in a state, according to an embodiment.

S1810, S1815, S1821 and S1822 in FIG. 18 may correspond to S1010, S1015, S1021 and S1022 in FIG. 10. Repetitive description is avoided.

The electronic apparatus 100 may operate in the standby state to output ultrasonic waves. The electronic apparatus 100 may identify a previous state of the standby state (S1816). The electronic apparatus 100 may store history information on a state in which an operation is performed. The electronic apparatus 100 may identify a previous state of the standby state, based on history information in relation to a change in the state.

The electronic apparatus 100 may identify a noise threshold value corresponding to the previous state (S1817). The electronic apparatus 100 may identify the state in which the electronic apparatus operated prior to the standby state, and identify a noise threshold value corresponding to the identified state. The electronic apparatus 100 may identify the noise threshold value corresponding to the previous state, based on the noise treatment information 1610 that depends on a change in the state in FIG. 16.

When identifying the noise threshold value, the electronic apparatus 100 may perform S1821 and S1822.

FIG. 19 is a view provided to explain an operation of applying different sensitivity to each sensing operation, according to an embodiment.

Referring to FIG. 19, the electronic apparatus 100 may store sensitivity treatment information 1910. The sensitivity treatment information may include information indicating which sensitivity is used to sense a user in a user sensing operation. As sensitivity becomes higher, a user may be sensed more readily. As sensitivity becomes lower, a user may not be sensed readily. The sensitivity may differ depending on the sort of a sensing operation.

The electronic apparatus 100 may determine whether a user is close in the first sensing operation, based on first sensitivity s1. The first sensitivity s1 may be included in an insensitive group. The first sensing operation may involve sensing a user in the state where the display 140 is off. In the case where sensitivity is relatively high in the first sensing operation, the display 140 is supplied with power too easily. The electronic apparatus 100 may use the first sensitivity s1 in the first sensing operation, to make it difficult to sense a user, thereby ensuring power efficiency.

The electronic apparatus 100 may determine whether a user is close, in the second sensing operation, based on second sensitivity s2. The second sensitivity s2 may be included in the insensitive group or an intermediate group. The second sensing operation may involve sensing a user by outputting ultrasonic waves in the state where the display 140 is off. The electronic apparatus 100 may use the second sensitivity s2 so that a predetermined screen may not be displayed on the display 140 too easily.

The electronic apparatus 100 may determine whether a user is close in the third sensing operation, based on third sensitivity s3. The third sensitivity may be included in a sensitive group. The third sensing operation may involve sensing a user in the state where the display 140 is on. The third sensing operation may involve sensing a user in the state where a predetermined screen is displayed on the display 140. The electronic apparatus 100 may use the third sensitivity s3 so that a user may be readily sensed while the predetermined screen displayed already is not turned off readily.

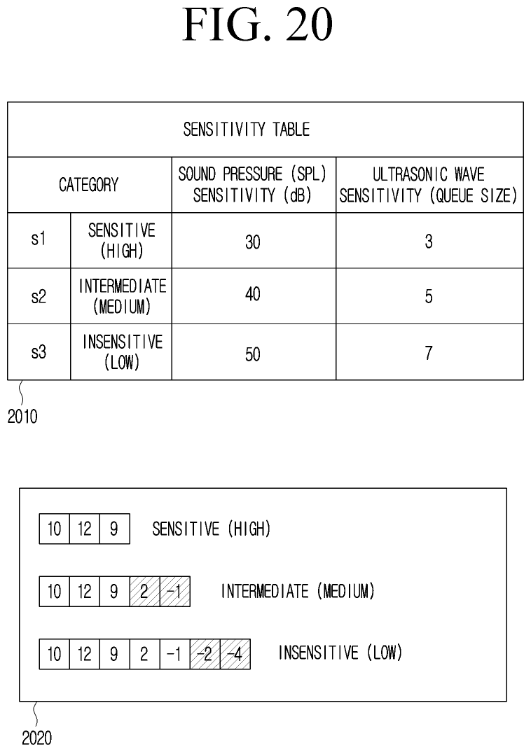

FIG. 20 is a view provided to explain sensitivity, according to an embodiment.

Referring to FIG. 20, the electronic apparatus 100 may store a sensitivity table 2010. The sensitivity table 2010 may include at least one of sound pressure sensitivity or ultrasonic wave sensitivity, based on classification ratings.

The sound pressure sensitivity may denote a threshold sound pressure that is a comparison object in the operation of comparing sound pressures. The ultrasonic wave sensitivity may include the number of obtained reflective waves that are used to identify whether a user is close. The electronic apparatus 100 may identify whether a user is close by using of a threshold number of reflective waves.

The electronic apparatus 100 may obtain a phase difference value based on (output) ultrasonic waves and (received) reflective waves. The electronic apparatus 100 may store the phase difference value in a queue. The ultrasonic wave sensitivity may be the size (a threshold number) of the queue.

In one example, the first sensitivity (a sensitive rating) may include at least one of first sound pressure sensitivity (e.g., 30 dB) or first ultrasonic wave sensitivity (e.g., the size of three queues).

In one example, the second sensitivity (an intermediate rating) may include at least one of second sound pressure sensitivity (e.g., 40 dB) or second ultrasonic wave sensitivity (e.g., the size of five queues).

In one example, the third sensitivity (an insensitive rating) may include at least one of third sound pressure sensitivity (e.g., 50 dB) or third ultrasonic wave sensitivity (e.g. the size of seven queues).

The first sensitivity may be less than the second sensitivity. The second sensitivity may be less than the third sensitivity.

The first sound pressure sensitivity may be less than the second sound pressure sensitivity. The second sound pressure sensitivity may be less than the third sound pressure sensitivity.

The first ultrasonic wave sensitivity may be less than the second ultrasonic wave sensitivity. The second ultrasonic wave sensitivity may be less than the third ultrasonic wave sensitivity.

Referring to an embodiment 2020 of FIG. 20, ultrasonic wave sensitivity corresponding to the first sensitivity (s1, sensitive) may include the size of three queues.

Ultrasonic wave sensitivity corresponding to the second sensitivity (s2, intermediate) may include the size of five queues.

Ultrasonic wave sensitivity corresponding to the third sensitivity (s3, insensitive) may include the size of seven queues.

In the case where the sensitivity changes from the first sensitivity to the second sensitivity in the second sensing operation (or third sensing operation), the electronic apparatus 100 needs to obtain two more phase difference values further.

In the case where the sensitivity changes from the second sensitivity to the third sensitivity in the second sensing operation (or third sensing operation), the electronic apparatus 100 needs to obtain two more phase difference values further.

According to an embodiment, the electronic apparatus 100 may use only one of the sound pressure sensitivity or the ultrasonic wave sensitivity, depending on the sort of a sensing operation.

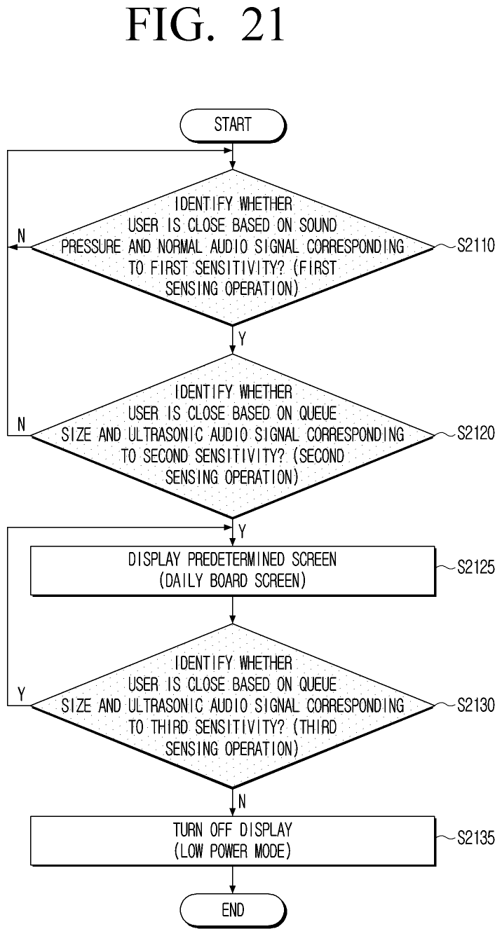

FIG. 21 is a view provided to explain an operation of applying different sensitivity to each sensing operation, according to an embodiment.

S2110, S2120, S2125, S2130 and S2135 in FIG. 21 may correspond to S410, S420, S425, S430 and S435 in FIG. 4. Repetitive description is avoided.

When preforming the first sensing operation, the electronic apparatus 100 may use the first sensitivity. The electronic apparatus 100 may identify whether a user is close, based on sound pressure (threshold sound pressure) and a normal audio signal (first audio signal) that correspond to the first sensitivity (S2110).

When performing the second sensing operation, the electronic apparatus 100 may use the second sensitivity. The electronic apparatus 100 may identify whether a user is close, based on a queue size (threshold number) and an ultrasonic audio signal (second audio signal) that correspond to the second sensitivity.

When performing the third sensing operation, the electronic apparatus 100 may use the third sensitivity. The electronic apparatus 100 may identify whether a user is close, based on a queue size (threshold number) and an ultrasonic audio signal (third audio signal) that correspond to the third sensitivity.

A queue size corresponding to the second sensitivity and a queue size corresponding to the third sensitivity may differ.

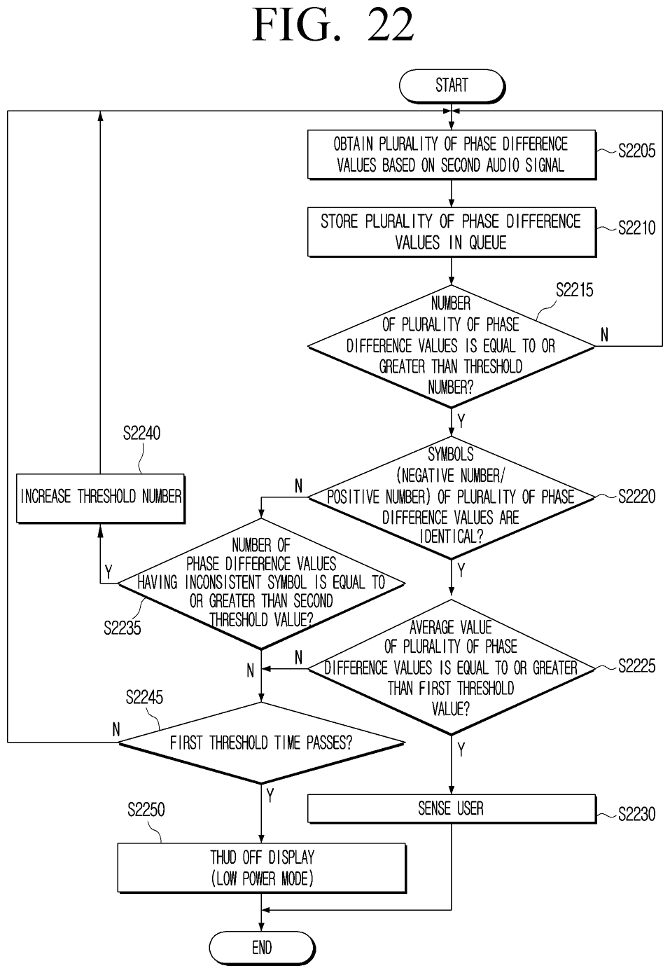

FIG. 22 is a view provided to explain an operation of adjusting sensitivity, according to an embodiment.

Referring to FIG. 22, the electronic apparatus 100 may perform the second sensing operation or the third sensing operation. The electronic apparatus 100 may obtain a plurality of phase difference values, based on the second audio signal (or third audio signal) (S2205). The electronic apparatus 100 may obtain a phase difference value, based on output ultrasonic waves and received reflective waves. The electronic apparatus 100 may identify whether the number of the plurality of phase difference values is equal to or greater than a threshold number (S2215). The threshold number may denote the size of a queue. The threshold number may be a value corresponding to define sensitivity.

In the case where the number of the plurality of phase difference values is less than the threshold number (S2215-N), the electronic apparatus 100 may repeat S2205, S2210 and S2215. The electronic apparatus 100 may repeat S2205, S2210 and S2215 until the threshold number of phase difference values is stored.

In the case where the number of the plurality of phase difference values is equal to or greater than the threshold number (S2215-Y), the electronic apparatus 100 may identify whether the symbol (negative number or positive number) of each of the plurality of phase difference values is identical (S2220).

The symbol of a phase difference value may differ depending on a direction in which a user approaches. In the situation where a user becomes close to the electronic apparatus 100, the electronic apparatus 100 may obtain a negative phase difference value. In the situation where a user becomes far from the electronic apparatus 100, the electronic apparatus 100 may obtain a positive phase difference value. The electronic apparatus 100 may identify a direction in which a user approaches, based on the symbol of a phase difference value.

In one example, in the case where the symbols of three phase difference values stored in a queue are +, + and +, the electronic apparatus 100 may identify that a user becomes far from the electronic apparatus 100.

In one example, in the case where the symbols of three phase difference values stored in a queue are −, − and −, the electronic apparatus 100 may identify that a user becomes close to the electronic apparatus 100.

The electronic apparatus 100 may identify whether the symbols of a plurality of phase difference values are identical. The electronic apparatus 100 may identify whether the symbols of the phase difference values are all positive (or negative).

In the case where the symbols of the plurality of phase difference values are all identical (S2220-Y), the electronic apparatus 100 may obtain an average value of the plurality of phase difference values. The electronic apparatus 100 may identify whether the average value of the plurality of phase difference values is equal to or greater than a first threshold value (S2225). The first threshold value may be a threshold value indicating that a user approaches.

Unless the average value of the plurality of phase difference values is equal to or greater than the first threshold value (S2225-N), it may be determined whether the first threshold time passes from the timepoint when the predetermined screen is displayed (S2245). As the first threshold time passes (S2245-Y), the electronic apparatus 100 may turn off the display 140 (S2250). The electronic apparatus 100 may operate in the low power state (low power mode).

Unless the first threshold time passes (S2245-N), the electronic apparatus 100 may obtain a new phase difference value. The electronic apparatus 100 may repeat step S2205-S2250.

In the case where the average value of the plurality of phase difference values is equal to or greater than the first threshold value (S2225-Y), the electronic apparatus 100 may identify that a user is sensed (S2230). The electronic apparatus 100 may identify that the user is present around the electronic apparatus 100. The electronic apparatus 100 may display the predetermined screen on the display 140.

Unless the symbols of the plurality of phase difference values are all identical (S2220-N), the electronic apparatus 100 may identify a phase difference value having an inconsistent symbol. The electronic apparatus 100 may identify whether the phase difference value having an inconsistent symbol is equal to or greater than a second threshold value (S2235). In the case where a plurality of phase difference values has an inconsistent symbol, the electronic apparats 100 may identify whether a plurality of average values is equal to or greater than the second threshold value. The first threshold value and the second threshold value may differ.

In one example, assume a queue storing +1, +2 and −1. A phase difference value having an inconsistent symbol may be −1.

In one example, assume a queue storing +1, −2 and −1. A phase difference value having an inconsistent symbol may be +1.

In the case where a phase difference value having an inconsistent symbol is equal to or greater than the second threshold value (S2235-Y), the electronic apparatus 100 may increase a threshold number (the threshold number in S2215) (S2240). S2240 may denote an operation of decreasing sensitivity. In the case where the symbols of phase difference values are inconsistent, the credibility of data may be deemed low. The electronic apparatus 100 may enhance the credibility of data by increasing an accumulative number of phase difference values.

As the threshold number increases, the electronic apparatus 100 may accumulate new phase difference values and include the same in a queue. The electronic apparatus 100 may repeat step S2205-S2250.

In the case where a phase difference value having an inconsistent symbol is less than the second threshold value (S2245-Y), the electronic apparatus 100 may turn off the display 140 (S2250). The electronic apparatus 100 may operate in the low power state.

According to an embodiment, when S2225 and S2235 are performed, an absolute value of a phase difference value may be used.

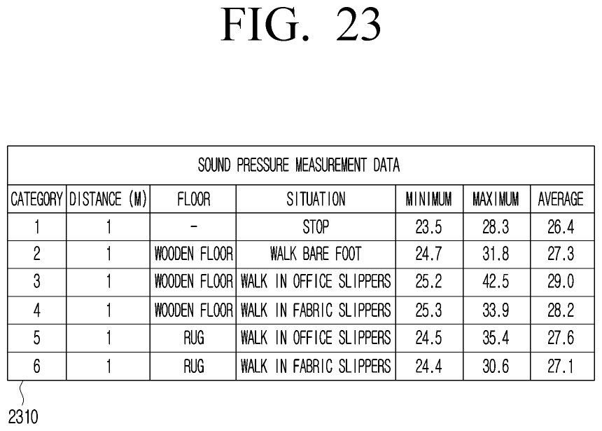

FIG. 23 is a view provided to explain sound pressure measurement data, according to an embodiment.

The table 2310 of FIG. 23 may indicate sound pressure measurement data. The table 2310 may indicate sound pressure data displayed in various situations. In an audio signal measured through the microphone 180, it may be primarily determined whether a user is close, only based on sound pressure. An operation in relation to this is described in S620 of FIG. 6. Predetermined sound pressure may be determined based on sound pressure of an audio signal generated by a user. The electronic apparatus 100 may determine predetermined sound pressure, based on the sound pressure measurement data described in the table 2310.

In one example, the electronic apparatus 100 may determine average sound pressure of various sound pressure measurement data in relation to a user as predetermined sound pressure.

FIG. 24 is a view provided to explain conditions for performing a noise test, according to an embodiment.

Referring to FIG. 24, the electronic apparatus 100 may perform a noise test. The noise test may be an operation for determining a noise threshold value. The noise test may be performed automatically. In one example, the electronic apparatus 100 may perform the noise test in every predetermined cycle. The electronic apparatus 100 may update the noise threshold value in every predetermined cycle.

The electronic apparatus 100 may identify whether ultrasonic waves are currently being output (S2405). Unless ultrasonic waves are being output (S2405-N), the electronic apparatus 100 may identify whether the electronic apparatus 100 is in a reset state (S2410). In the reset state (S2410-Y), the electronic apparatus 100 may perform the noise test (S2435).

Unless the electronic apparatus 100 is in the reset state (S2410-N), the electronic apparatus 100 may identify whether the current state is the low power state (S2415). In the low power state (or low power mode) (S2415), the electronic apparatus 100 may identify whether current time is included in predetermined time (S2420). The predetermined time may denote an update cycle.

In the case where the current time is included in the predetermined time (S2420-Y), the electronic apparatus 100 may identify whether the number of noise threshold values stored accumulatively is equal to or greater than a threshold number (S2425). The threshold number in S2425 may differ from the threshold number of queues described above (S2215 of FIG. 22). The electronic apparatus 100 may determine an average of three accumulated noise threshold values as a final noise threshold value. The electronic apparatus 100 may identify the number of noise threshold values stored accumulatively.

In the case where the number of the noise threshold values stored accumulatively is less than the threshold number (S2425-N), the electronic apparatus 100 may identify whether first time passes from the timepoint of a recent test (S2430). The timepoint of a recent test may denote a timepoint when a test performed most recently is completed (or finished).

As the first time passes from the timepoint when the recent test ends (S2430-Y), the electronic apparatus 100 may perform a noise test (S2435).

In the case where the number of the noise threshold values stored accumulatively is the threshold number or grater (S2425-Y), the electronic apparatus 100 may identify whether second time passes from the timepoint of the recent test (S2440). The second time may be greater than the first time. In one example, the first time may be one day, and the second time may be one week. This is because in the case where sufficient noise threshold values are already accumulated, there is no need to update the noise threshold values often.

As the second time passes from the timepoint of the recent test (S2440-Y), the electronic apparatus 100 may perform the noise test (S2435).

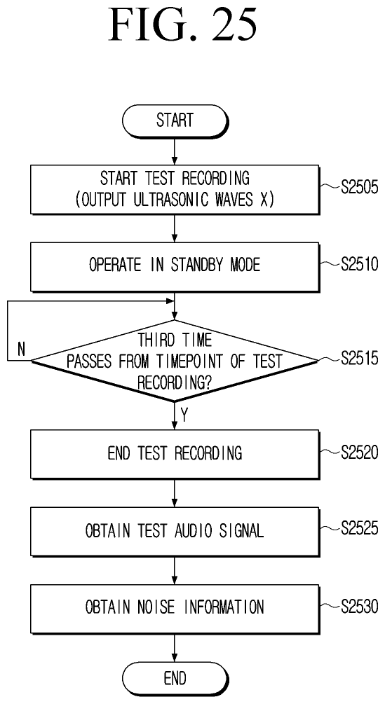

FIG. 25 is a view provided to explain an operation of obtaining noise information, according to an embodiment.

Referring to FIG. 25, the electronic apparatus 100 may start a test recoding (S2505). The electronic apparatus 100 may start a test recording in the state where the electronic apparatus does not output ultrasonic waves.

The electronic apparatus 100 may operate in the standby state (or standby mode), for the test recording (S2510). The electronic apparatus 100 may identify whether predetermined time (third time) passes from the timepoint of the test recording (S2515). As the predetermined time (third time) passes from the timepoint of the test recording (S2515-Y), the electronic apparatus 100 may end the test recording (S2520).

The electronic apparatus 100 may obtain a test audio signal, based on the test recording (S2525). The electronic apparatus 100 may obtain (or extract) noise information from the test audio signal (S2530).

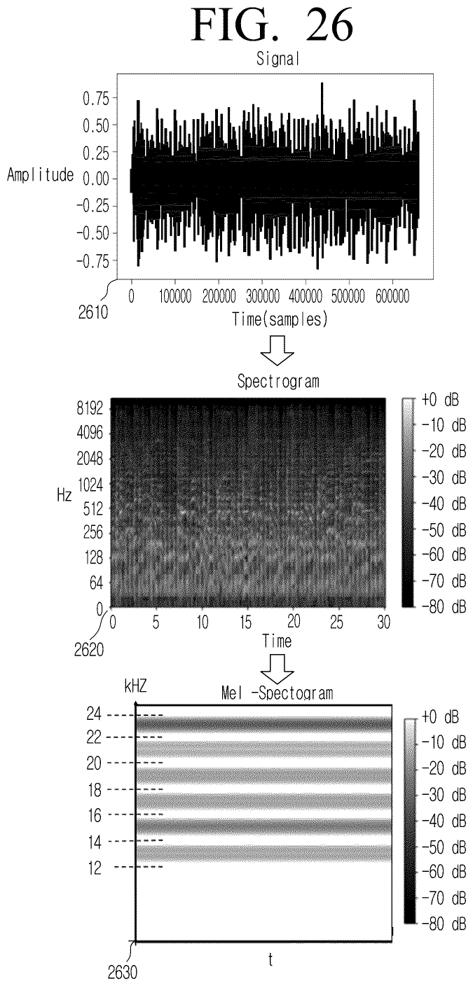

FIG. 26 is a view provided to explain a process of obtaining noise information, according to an embodiment.

Referring to FIG. 26, the electronic apparatus 100 may obtain a test audio signal 2610. The test audio signal 2610 may denote the size of sound pressure based on time.

The electronic apparatus 100 may convert the test audio signal 2610 into a spectrogram signal 2620. The spectrogram may indicate a change in a frequency component based on time.

The electronic apparatus 100 may obtain a mel spectrogram signal 2630 from the spectrogram signal 2620. A mel spectrogram may show audio frequency recognition properties based on time by converting the axis of a spectrogram into a mel scale. The mel scale may be a criterion for converting frequencies based on the audio recognition of a human.

For example, at low frequencies, even a slight change in the frequencies may be recognized as a big difference. At high frequencies, a big change in the frequencies may be recognized. The mel scale may be a value in which such a recognition is quantified and which shows a relationship between a physical change in frequencies and an audible experience of a human.

In the mel spectrogram 2630, an identical change in frequencies may be shown as an identical change in sizes.

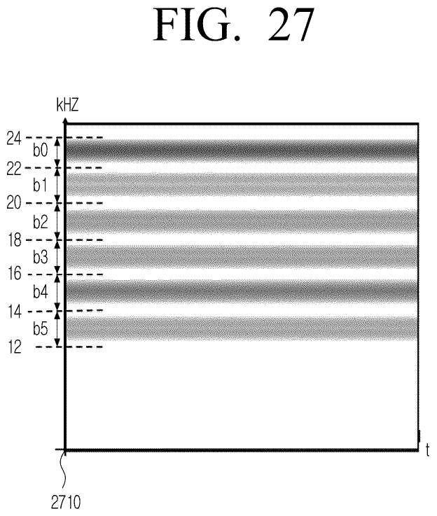

FIG. 27 is a view provided to explain noise information on a plurality of bands, according to an embodiment.

Referring to FIG. 27, the electronic apparatus 100 may obtain a mel spectrogram signal 2710. The mel spectrogram signal 2710 may correspond to the mel spectrogram signal 2630 of FIG. 26.

The electronic apparatus 100 may analyze noise based on the mel spectrogram signal 2710. The mel spectrogram signal 2710 may include signals in relation to various frequency bands b0, b1, b2, b3, b4 and b5. Noise may be extracted based on the remaining bands b1, b2, b3, b4 and b5 except for an ultrasonic band b0 among the various frequency bands.

The electronic apparatus 100 may calculate average sound pressure mel-SPL of a signal existing in each of a plurality of predetermined bands b0, b1, b2, b3, b4 and b5. The electronic apparatus 100 may calculate the average sound pressure as a noise size of each band.

The electronic apparatus 100 may obtain the average sound pressure of the ultrasonic band b0 as an ultrasonic wave size.

The electronic apparatus 100 may obtain average sound pressure of a first band b1 as a first noise size. The electronic apparatus 100 may obtain average sound pressure of a second band b2 as second noise size. The electronic apparatus 100 may obtain average sound pressure of a third band b3 as third noise size. The electronic apparatus 100 may obtain average sound pressure of a fourth band b4 as fourth noise size. The electronic apparatus 100 may obtain average sound pressure of a fifth band b5 as fifth noise size.

The electronic apparatus 100 may compare the ultrasonic wave size with the noise sizes to identify whether an electronic device outputting ultrasonic waves is present around the electronic apparatus 100.

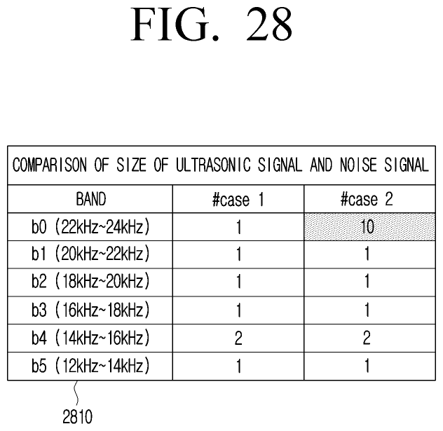

FIG. 28 is a view provided to explain an operation of analyzing noise information on a plurality of bands, according to an embodiment.

Referring to an embodiment 2810 of FIG. 28, the electronic apparatus 100 may compare the size of a signal that is respectively obtained in the plurality of bands.

In one example, the size of a signal corresponding to each of a plurality of predetermined bands b0, b1, b2, b3, b4 and b5 may be 1, 1, 1, 1, 2 and 1. The electronic apparatus 100 may obtain a signal size 1 of the ultrasonic band b0 as a first size. The electronic apparatus 100 may obtain a biggest signal size 2 as a second size among the remaining bands. Since the first size 1 is less than the second size 2, the electronic apparatus 100 may identify that an external electronic device outputting ultrasonic waves is not present around the electronic apparatus 100. The electronic apparatus 100 may determine that the reliability of the obtained noise information is high.

In one example, the size of a signal corresponding to each of the plurality of predetermined bands b0, b1, b2, b3, b4 and b5 may be 10, 1, 1, 1, 2 and 1. The electronic apparatus 100 may obtain a signal size 10 of the ultrasonic band b0 as a first size. The electronic apparatus 100 may obtain a biggest signal size 2 as a second size among the remaining bands. Since the first size 10 is greater than the second size 2, the electronic apparatus 100 may identify that an external electronic device outputting ultrasonic waves is present around the electronic apparatus 100. The electronic apparatus 100 may determine that the reliability of the obtained noise information is low.

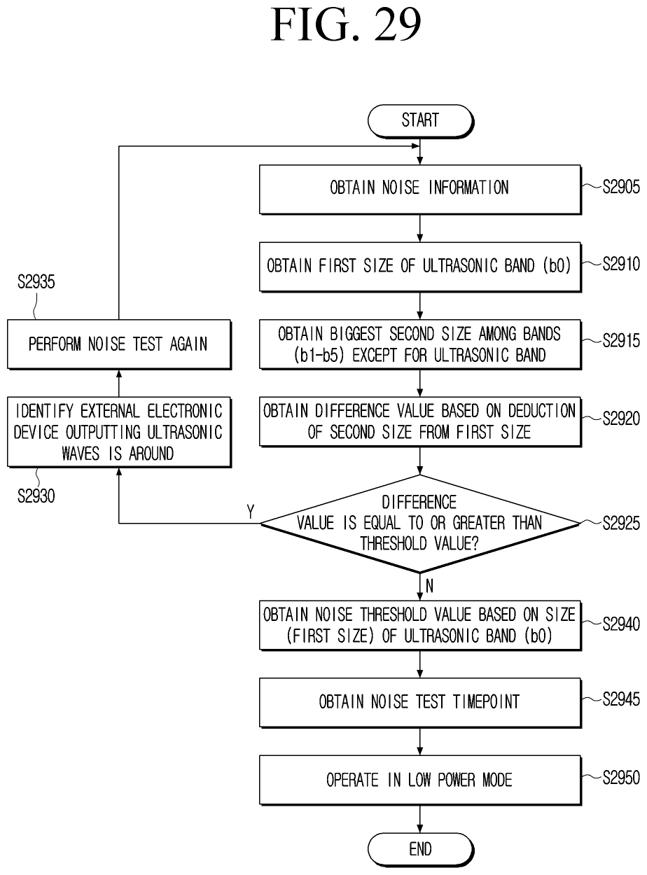

FIG. 29 is a view provided to explain an operation of performing a noise test, according to an embodiment.

Referring to FIG. 29, the electronic apparatus 100 may obtain noise information (S2905). The electronic apparatus 100 may obtain average sound pressure of the ultrasonic band b0 as a first size (or first signal size) (S2910).

The electronic apparatus 100 may obtain biggest average sound pressure among the bands b1, b2, b3, b4 and b5 except for the ultrasonic band as a second size (or second signal size) (S2915).

The electronic apparatus 100 may obtain a difference value based on a deduction of the second size from the first size (S2920). The electronic apparatus 100 may identify whether the difference value is equal to or greater than a threshold value (S2925). In the case where the difference value is equal to or greater than the threshold value (S2925-Y), the electronic apparatus 100 may identify that an external electronic device outputting ultrasonic waves is present around the electronic apparatus 100 (S2930). The electronic apparatus 100 may perform the noise test again (S2935). The electronic apparatus 100 may obtain noise information newly, based on the noise test performed again. The electronic apparatus 100 may repeat step S2905 to S2935.

In the case where the difference value is less than the threshold value (S2925-N), the electronic apparatus 100 may obtain a noise threshold value based on the first size of the ultrasonic band b0 (S2940). The electronic apparatus 100 may determine the first size as the noise threshold value.

The electronic apparatus 100 may obtain a noise test timepoint (S2945). The noise test timepoint may denote a timepoint when a test is completed (or finished).

The electronic apparatus 100 may operate in the low power state (S2950). As the noise test is completed, the state of the electronic apparatus 100 may change to the low power state (or low power mode) from the standby state (or standby mode).

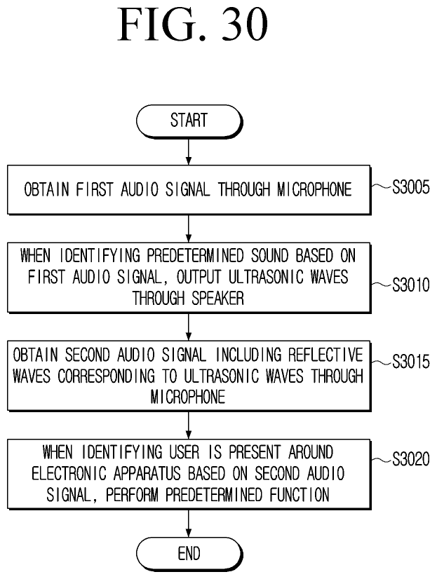

FIG. 30 is a view provided to explain according to an embodiment.

Referring to FIG. 30, a control method of an electronic apparatus including a speaker and a microphone includes obtaining a first audio signal though the microphone (S3005), when a predetermined sound is identified based on the first audio signal, outputting ultrasonic waves through the speaker (S3010), obtaining a second audio signal including reflective waves corresponding to the ultrasonic waves through the microphone (S3015), and when it is identified that a user is present around the electronic apparatus based on the second audio signal, performing a predetermined function (S3020).

A predetermined sound may include at least one of a human voice or an artificial sound generated by human behavior.

The control method may include obtaining average sound pressure of the first audio signal, and when the average sound pressure is equal to or greater than predetermined sound pressure, and determining whether the predetermined sound is identified based on the first audio signal.

The control method may include when the predetermined sound is identified based on the first audio signal, identifying whether the electronic apparatus is in a state where output of ultrasonic waves is impossible, and when the electronic apparatus 100 is not in the state where output of ultrasonic waves is impossible, outputting the ultrasonic waves through the speaker, and the ultrasonic-wave output impossible state may include a state in which at least one of the speaker or the microphone is activated.

The control method may include obtaining the first audio signal while the electronic apparatus operates in the low power state, and when the electronic apparatus is not in the state where output of ultrasonic waves is impossible, changing the low power state to the standby state.

The control method may include filtering out noise from the second audio signal based on a noise threshold value stored previously and obtaining a target audio signal, identifying reflective waves corresponding to the ultrasonic waves from the target audio signal, and identifying whether a user is present around the electronic apparatus based on the ultrasonic waves and the reflective waves.

The control method may include obtaining a phase difference value based on a first phase of the ultrasonic waves and a second phase of the reflective waves, and when the phase difference value is equal to or greater than a phase threshold value, identifying that the user is present around the electronic apparatus.

The step of performing a predetermined function may include displaying a predetermined screen when it is identified that the user is present around the electronic apparatus, and the predetermined screen may include at least one of a time UI, a weather UI, a schedule UI, an indoor environment UI, and/or a guide UI.

The ultrasonic waves are first ultrasonic waves, while the reflective waves are first reflective waves, and the control method may include after the predetermined screen is displayed, outputting second ultrasonic waves through the speaker, obtaining a third audio signal including second reflective waves corresponding to the second ultrasonic waves through the microphone, and when it is identified that the user is present around the electronic apparatus based on the third audio signal, displaying the predetermined screen continuously.

The control method includes obtaining a first average value of a first threshold number of phase difference values corresponding to first sensitivity from the second audio signal, when the first average value is equal to or greater than the phase threshold value, displaying the predetermined screen, obtaining a second average value of a second threshold number of phase difference values corresponding to second sensitivity from the third audio signal, when the second average value is less than the phase threshold value, displaying the predetermined screen, and the first threshold number is greater than the second threshold number.

Methods according to the embodiments of the present disclosure, described above, may be realized in an application form installable in exiting electronic apparatuses.

Methods according to the embodiments of the present disclosure, described above, may be realized by upgrading software or hardware of existing electronic apparatuses.

The embodiments of the present disclosure, described above, may be performed through an embedded server provided in an electronic apparatus, or an external server of at least one of an electronic apparatus and a display device.

According to embodiments, the embodiments described above may be implemented with software including instructions stored in a storage medium readable by a machine (e.g., a computer). The machine, as a device capable of calling the stored instructions from the storage media and operating according to the called instructions, may include an electronic apparatus according to the disclosed embodiments. Based on instructions executed by a processor, the processor may perform functions corresponding to the instructions directly or by using other elements under the control of the processor. The instructions may include a code generated or executed by a compiler or an interpreter. The machine-readable storage medium may be provided in the form of a non-transitory storage medium. Herein, the term “non-transitory” means that the storage medium does not include a signal and only means that the storage medium is tangible, while the term does distinguish semi-permanent or temporary storage of data in the storage medium.

According to embodiments, the method in various embodiments described above may be provided in a computer program product. The computer program product may be exchanged between a seller and a purchaser as a commodity. The computer program product may be distributed in the form of a machine-readable storage medium (e.g., compact disc read only memory (CD-ROM)) or distributed online through an application store. In the case of online distribution, at least a portion of the computer program product may be stored at least temporarily, or generated temporarily in a storage medium such as a manufacturer's server, a server of an application store, or memory of a relay server.

In addition, each of the elements (e.g., a module or a program) according to the embodiments described above may be composed of a single entity or a plurality of entities, and some of the corresponding sub elements described above may be omitted, or another sub element may be further included in the embodiments. Alternatively or additionally, some elements (e.g., modules or programs) may be integrated into one entity to perform identical or similar functions performed by each corresponding element prior to integration. Operations performed by a module, a program, or another element, according to the embodiments, may be performed sequentially, in parallel, repetitively, or heuristically manner, or at least some operations may be performed in a different order, omitted, or may add a different operation.

While example embodiments of the present disclosure are illustrated and described above, embodiments thereof are not limited to the embodiments set forth herein, and certainly, various modifications thereof may be made by one skilled in the art to which the present disclosure pertains, without departing from the scope the disclosure, claimed in the section of claims, and should not be understood as separating from the technical spirit of the disclosure.

1. An electronic apparatus comprising:
memory configured to store instructions;
a display;
a speaker;
a microphone; and
at least one processor including processing circuitry,
wherein the instructions, when executed by the at least one processor individually or collectively, cause the electronic apparatus to:
based on a predetermined sound being identified based on a first audio signal obtained through the microphone, output ultrasonic waves through the speaker; and
based on identifying that a user is present around the electronic apparatus based on a second audio signal obtained through the microphone and including reflective waves corresponding to the ultrasonic waves output through the speaker, perform a function corresponding to presence of the user.

2. The electronic apparatus as claimed in claim 1, wherein the predetermined sound includes an artificial sound based on human behavior.

3. The electronic apparatus as claimed in claim 1, wherein the instructions, when executed by the at least one processor individually or collectively, cause the electronic apparatus to:
obtain an average sound pressure of the first audio signal, and
based on the average sound pressure being equal to or greater than a predetermined sound pressure, determine whether the predetermined sound is identified based on the first audio signal.

4. The electronic apparatus as claimed in claim 1, wherein the instructions, when executed by the at least one processor individually or collectively, cause the electronic apparatus to:
based on the predetermined sound being identified based on the first audio signal, identify whether the electronic apparatus is in a state in which output of ultrasonic waves is impossible, and
based on identifying that the electronic apparatus is not in a state in which output of ultrasonic waves is impossible, output the ultrasonic waves through the speaker, and
wherein the state in which output of ultrasonic waves is impossible includes a state in which at least one of the speaker or the microphone is activated.

5. The electronic apparatus as claimed in claim 4, wherein the instructions, when executed by the at least one processor individually or collectively, cause the electronic apparatus to:
obtain the first audio signal while the electronic apparatus operates in a low power state, and
based on the electronic apparatus not being in a state in which output of ultrasonic waves is impossible, change the low power state to a standby state.

6. The electronic apparatus as claimed in claim 1, wherein the instructions, when executed by the at least one processor individually or collectively, cause the electronic apparatus to:
obtain a target audio signal by filtering out noise from the second audio signal based on a noise threshold value, and
identify whether the user is present around the electronic apparatus based on the ultrasonic waves and reflective waves corresponding to the ultrasonic waves obtained from the target audio signal.

7. The electronic apparatus as claimed in claim 6, wherein the instructions, when executed by the at least one processor individually or collectively, cause the electronic apparatus to:
obtain a phase difference value based on a first phase of the ultrasonic waves and a second phase of the reflective waves obtained from the target audio signal, and
based on the phase difference value being equal to or greater than a phase threshold value, identify that the user is present around the electronic apparatus.

8. The electronic apparatus as claimed in claim 7, further comprising:
a display,
wherein the instructions, when executed by the at least one processor individually or collectively, cause the electronic apparatus to:
based on identifying that the user is present around the electronic apparatus, control the display to display a predetermined screen, and
wherein the predetermined screen includes at least one of a time UI, a weather UI, a schedule UI, an indoor environment UI or a guide UI.

9. The electronic apparatus as claimed in claim 8, wherein
the ultrasonic waves are first ultrasonic waves,
the reflective waves obtained from the target audio signal are first reflective waves, and
wherein the instructions, when executed by the at least one processor individually or collectively, cause the electronic apparatus to:
output second ultrasonic waves through the speaker, after displaying the predetermined screen,
obtain a third audio signal including second reflective waves corresponding to the second ultrasonic waves through the microphone, and
based on identifying that the user is present around the electronic apparatus based on the third audio signal, control the display to display the predetermined screen continuously.

10. The electronic apparatus as claimed in claim 9, wherein the instructions, when executed by the at least one processor individually or collectively, cause the electronic apparatus to:
obtain a first average value of a first threshold number of phase difference values corresponding to a first sensitivity from the second audio signal,
based on the first average value being equal to or greater than the phase threshold value, control the display to display the predetermined screen,
obtain a second average value of a second threshold number of phase difference values corresponding to a second sensitivity from the third audio signal, and
based on the second average value being less than the phase threshold value, control the display not to display the predetermined screen, and
wherein the first threshold number is greater than the second threshold number.

11. A control method of an electronic apparatus including a speaker and a microphone, the control method comprising:
based on a predetermined sound being identified based on a first audio signal obtained through the microphone, outputting ultrasonic waves through the speaker; and
based on identifying that a user is present around the electronic apparatus based on a second audio signal obtained through the microphone and including reflective waves corresponding to the ultrasonic waves output through the speaker, performing a function corresponding to presence of the user.

12. The control method as claimed in claim 11, wherein the predetermined sound includes an artificial sound based on human behavior.

13. The control method as claimed in claim 11 comprising:
obtaining an average sound pressure of the first audio signal; and
based on the average sound pressure being equal to or greater than a predetermined sound pressure, determining whether the predetermined sound is identified based on the first audio signal.

14. The control method as claimed in claim 11 comprising:
based on the predetermined sound being identified based on the first audio signal, identifying whether the electronic apparatus is in a state in which output of ultrasonic waves is impossible; and
based on identifying that the electronic apparatus is not in a state in which output of ultrasonic waves is impossible, outputting the ultrasonic waves through the speaker,
wherein the state in which output of ultrasonic waves is impossible includes a state in which at least one of the speaker or the microphone is activated.

15. The control method as claimed in claim 14 comprising:
obtaining the first audio signal while the electronic apparatus operates in a low power state; and
based on the electronic apparatus not being in a state in which output of ultrasonic waves is impossible, changing the low power state to a standby state.

16. An electronic apparatus comprising:
a microphone;
a speaker;
at least one processor; and
memory storing instructions that, when executed by the at least one processor, cause the electronic apparatus to:
obtain, through the microphone, a first audio signal,
based on a predetermined sound being identified based on a first audio signal obtained through the microphone, output ultrasonic waves through the speaker,
obtain, through the microphone, a second audio signal including reflective waves corresponding to the ultrasonic waves output through the speaker, and
based on identifying that a user is present around the electronic apparatus based on the second audio signal obtained through the microphone, perform a function corresponding to presence of the user.
